(19) United States
(12) Patent Application Publication
(10) Pub. No.: US 2008/0133274 A1
(43) Pub. Date: Jun. 5, 2008

(54) ELECTRONICALLY DOCUMENTED MEDICAL RECORD and MEDICARE BILLING FORMS GENERATION SYSTEM

(76) Inventor: William Scott WARNER, Friendswood, TX (US)

Correspondence Address: KAREN A. REX, 950 Gemini, Suite 6, HOUSTON, TX, 77058, US

(21) Appl. No.: 11/873,814

(22) Filed: Oct. 17, 2007

Related U.S. Application Data
(63) Continuation-in-part of application No. 09/547,974, filed on Apr. 12, 2000, now abandoned.
(60) Provisional application No. 60/128,987, filed on Apr. 12, 1999.

(51) Int. Cl. G06Q 50/00; G06F 3/14

(52) U.S. Cl. 705/3

(57) ABSTRACT

A medical billing and records generating system is provided having a client/server communications system using a dedicated host/server to control a network and nodes, including client nodes, connected to the network, and server resident software and applications. The system produces completed billing and medical records forms, the substantive content of which is documented by the system before the form is generated, and which are not hand written and always legible. The system captures patient data at the point of its generation, incorporates it into a database. Database management software processes the data to pre-fill various template forms used for patient care in a browser application linked to the system via a client node, and permits pre-filled data to be amended to reflect current patient care data, and used to update the patient's record in the database. The system also retrospectively fills billing forms using previously verified patient data.

The present application claims the benefit of prior filed U.S. Non-Provisional application Ser. No. 09/547,974, filed 12 Apr. 2000, which in turn claimed the benefit of U.S. Provisional Application Ser. No. 60/128,987, filed 12 Apr. 1999; to which applications the present application is a continuation-in-part, and which applications are incorporated herein by reference.

### FIELD OF THE INVENTION

The present invention relates to information processing systems organization, and to data processing in the medical field. More specifically, the present invention relates to a client/server system for collecting, displaying, managing and correlating patient data, medical records data and care codes data for processing and producing billing and patient record forms that are electronically documented before a hardcopy form is generated.

### BACKGROUND OF THE INVENTION

In 1965, the U.S. Congress amended the Social Security statutes to mandate a program of health insurance for Americans sixty-five years of age and older, certain disabled people and patients with end-stage renal disease. In 1966 this legislation gave rise to the program now known in the U.S. as Medicare. Medicare is managed by the Health Care Financing Administration, a branch of the U.S. Health and Human Services agency. Over the past thirty years the program has grown substantially. Further, the program requirements have become benchmark in the health care industry for billing claims against medical care payors.

Problematic accounting requirements within the Medicare system were recognized early on in the program. Originally, the accounting records were made by hand and calculations were made using mechanical calculators. Hence, original accounting and billing methods were slow and subject to an unacceptable degree of inherent error. In view of this, the Medicare field was motivated early on to develop improved methods of Medicare accounting. For example, in 1968, only two years after the program's initiation, Frees filed a patent application on a “Medicare Calculator” (U.S. Pat. No. 3,567,114). The Frees' calculator was a mechanical device, very much like a circular slide rule, for indicating a patient's cost for care received and the total Medicare cost of the care based on the number of days the patient was under medical care. Although this device was rudimentary and the information inadequate by today's needs, it does show the early motivation in the field for developing medicare specific accounting methods.

The advent of the mini-computer and computer networks made possible the decentralization of access to the computing power available at medical institutions and hospitals. In view of this accessability, the medical field saw a potential for benefit which generated further motivation to bring the physician, as the primary care provider, directly into the Medicare accounting process. Mohlenbrock et al. (U.S. Pat. No. 4,667,292) disclose a computer based system which enables an attending physician to select from a list of billing categories for medical services, a billing category for reimbursement by a medical services payor. The Mohlenbrock et al. system provides assistance in the selection of a payment category from a list of predetermined payment categories. Although Mohlenbrock et al. in the '292 patent states that upon admission to the hospital, patient information is a part of their system, they do not teach or suggest any patient data other than age and sex is relevant to the selection of a payment category. Also, the databases disclosed in the '292 patent are read only databases. Any inputs to the system by the physician are for calculation purposes, and do not modify the disclosed databases. A disadvantage of the Mohlenbrock et al. system is that a hospital would be reimbursed according to a fixed schedule of payments which is unresponsive to the actual costs of rendering medical care to the patient.

In view of this disadvantage and changes in the Medicare laws, the field was motivated to develop further improved Medicare accounting systems. In a subsequent patent, Mohlenbrock et al. (U.S. Pat. No. 5,018,067) disclosed an improved system for estimating and monitoring medical costs. This system extracts information from the same data used by their prior Diagnostic Related Groups (DRG) based system to assist in the selection of payment subcategories which are more responsive to actual costs of care provided to a patient.

A further effort was made by Dome (U.S. Pat. No. 5,325,293) to correlate medical procedures with medical billing codes. Dome discloses a system which provides a catalogue or list of medical procedures with corresponding “raw codes;” a means of analyzing a subset of the raw codes to generate a set of “intermediate codes;” and using the intermediate codes to produce a set of billing codes. The billing codes may be output on a printer. The Dome system has the advantage over the earlier Mohlenbrock et al. system in that it can access a patient's prior record. However, Dome has a disadvantage in that its teachings are specifically directed to interventional radiology and ignore the other medical specialties along with their unique Medicare billing requirements.

Today's Medicare billing field is confronted with substantial problems, not only in relation to accounting, but also to accountability. Although accountability has always been a concern in the Medicare billing field, that concern intensified in 1993 when the U.S. Attorney General's office announced it was cracking down on health care fraud. As a result of the crack down, news reports indicate that criminal prosecutions for health care fraud have more than tripled in recent years, and medical professionals—from doctors to administrators—are going to prison in record numbers. For example, it is reported that the government collected $42 million in overpayments and fines from two Philadelphia hospitals. These prosecutions involve not only inflated or fraudulent billing claims, but also claims involving insufficient justification (or documentation) and ordinary mistakes. It is reported that over two billion dollars in Medicare overpayments are attributable to “documentation errors.” While it is difficult to design a billing system that can withstand intentional efforts to defraud, certainly it would be beneficial to have such a system which can reduce or eliminate the risk of a government legal action, fines and imprisonment due to an unintentional mistake, or insufficient documentation to justify a billing claim.

The specter of accountability has further motivated the Medicare billing field to seek additional alternatives and improvements in Medicare billing systems. For example, Sear et al. (U.S. Pat. No. 5,557,514) discloses a method and system for prospectively analyzing historical medical care billings. The disclosed purpose being to statistically establish patterns of treatment utilization for various medical services. Apparently, inherent in the system is the capability to audit medical billing claims and detect fraud and mistake. Although the '514 patent can provide the benefit of detecting a billing mistake once it has occurred, it would be beneficial to have a billing system that checked for and prevented such mistakes before the billing claims were made. Clearly, it would be of material benefit to the Medicare field if improved billing systems were available to address not just billing, but also accountability.

### SUMMARY OF THE INVENTION

The present invention is a network based, client/server system for collecting, displaying, managing and correlating patient data, medial records data and medical care codes data for processing and producing billing documents and medical records documents. The present application claims the benefit of prior filed U.S. Provisional Application Ser. No. 60/128,987, filed 12 Apr. 1999 to which the present application is a regular U.S. national application, the subject matter of which is incorporated herein by reference.

The system of the present invention is a network that comprises a client/server communications network; that uses a dedicated server for serving all nodes on the network; a host/server that controls the network environment; nodes connected to the server via the network, and server resident software applications with software modules for accomplishing the systems functions. An object of the present invention is a medical billing and records generating system for producing completed billing and medical records forms, the substantive content of which is documented by the system before the form is generated, and which are not hand written and therefore always legible. The present system captures certain patient data at the point of its generation, incorporates the patient data into a database and processes the data to fill out the various hardcopy forms used for patient care in a medical environment. Hardcopies include patient history forms, billing forms, patient interview forms and similar patient history and care related forms.

The present invention electronically generates medical billing forms and medical record forms, fills in the data fields on the forms using verified data from an internal database, and then prints out a hardcopy of the documented forms. The printed forms generating system of the present invention comprises a client/server communications network and associated hardware, software and interface components. Generally, the components of the present system are a client/server network, a dedicated server, software, a database, nodes and a printer.

The client/server communications network interfaces a dedicated host/server with all of the nodes on the network. The communications network is an arrangement of interfaces and transmission channels connecting the dedicated host/server with all nodes, and with supporting hardware and software in the system. The communications network further comprises connections of various types interfacing the host/server with the nodes. Examples of connections include: hard wired connections, wireless connections, networked connections, and switched (modem or telephone) connections.

A dedicated host/server is connected to the client/server network and controls the network, and processes and stores data in the database. The host/server is “dedicated” in that it is not shared by any other clients outside the network. In the present system, the host/server is the main computer in the client/server communications network, and provides for controlling all network operations. The dedicated host/server can be a microcomputer, a minicomputer or a mainframe computer. Examples of computers that are practicable as the dedicated server of the present invention include any of the server-class products commercially available from Hewlett Packard, Compaq, Sun, IBM and Apple. Mainframe computers practicable as the dedicated server are available from IBM, Control Data and Amdahl. Other devices useful for accomplishing the dedicated server of the present invention are known to one of ordinary skill in the art.

The software resident on the host/server includes client/server protocols for operating the system in the usual manner of client/server networks, and for the purposes of the present invention as well. In addition to the usual operating system software for the operation of a server, the present software further comprises server applications software, system organization and management software, data processing software and database management software for the practice of the system. Particularly, the present software provides for the host/server receiving, managing, processing and transmitting patient data, medical records data, billing data, medical care codes data and forms data for accomplishing the printed forms and for managing the database of the present invention. An important function of the software is to create and transmit digital format data that presents an interactive form for presentation in the window of the browser application at a client node. An example of commercially available software applications useful in accomplishing these is the MS IIS (Internet Information Server).

The organization and management software of the present invention includes security and user management software for controlling access to the network, and access to the databases and data processing functions of the system. Security is an integral part of the system; access and presentation of data is granted to users based on their access levels. For example, if the user is a care provider, his/her area of practice and permission set defines which forms screen is presented to them in the browser window. Security functions are managed and controlled by a database program whose function it is to define a permission set that determines what level of clearance a user has.

The database of the present invention is a set of interrelated files that is created and managed by the database management software. The database is resident on the host/server and includes all of the electronically stored data in the system. The database is used to store static and dynamic data. Dynamic data can include patient data, forms data, billing data, physician assessment data, lab data, other test and assessment data, and medical procedures data. Other more static data, are stored as document files, image files, template files and application files or other file types as appropriate for the type of data involved. Data includes browser page formats used for entering or presenting data on a viewer as well as the data content of the browser pages. Preferably, the formatting of the browser pages is designed to be familiar to a user (e.g., a patient care provider).

The database comprises all the data necessary to practice the present system, including user data, patient data, forms data, billing data, care codes data, medical data, and administrative data. These data typically are contained in relational databases.

A node is a junction or point of connection where the network interfaces with a terminal, computer, or other input/output (I/O) port or device. A client is a work station, personal computer or the like, and a client node is a node where a client is connected to the network. A “client” is a type of node, while a “user” typically is a person accessing the server via the network from a node at an applications level. A client node supports and operates a client side browser application for presenting the digital format data received from the server in a window of the browser application. In addition to being a client node, a node can be a printer, a terminal, an I/O port or another network. Preferably, a client node comprises a computer, a viewer and an interface to a printer. The viewer typically is a computer screen, but any other methods of viewing the content presented in the window of the browser application is likely practicable in the present system. The viewer provides for visually presenting the digital forms data generated by the server and transmitted to the browser. The viewer may comprise a cathode ray tube, a liquid crystal display, or other such appropriate display device as are known in the art.

A printer is included for implementing a print function of the browser application to generate a printout of the digital format presented in the browser window as a printed form. It is intended that the documents or forms that are output from the system include content and format compatible with medical billing requirements, medical records, and other patient care forms of the user. Such forms being useful for meeting the billing requirements of both Medicare and any non-medicare payor.

The present invention includes a process for generating and printing an electronically documented, medical billing and record form. An example of the present process comprises: providing a client/server network having a dedicated host/server with software resident on the server for receiving, managing, processing and transmitting patient data, medical records data, medical care codes data and forms data in a digital format, and for communicating with a client node via a browser application, and a client node supporting a client side browser application for communicating with the host/server and a printer.

A user at a client node calls up the client side browser application. Using the browser, the user links the client node to the host/server via the network, and then uses the client side browser to communicate with the server. Upon initiation of communication, the server runs a session initialization module which requests the user's identification, and either rejects the user's log-in attempt or admits the user access to the system, based on whether the system recognizes the user's I.D. An admitted user is assigned a tracking tag (user number) and a permission set by the security protocol module. The permission set determines the security level assigned to the user for this session.

Upon receiving a valid log-in attempt, the system transmits an acknowledgment screen back to the client node. Typically, the acknowledgment screen is an initial interactive forms screen. The client node presents the initial screen data transmitted by the host/server in the window of the client side browser application. The transferring of data between the client node and the host/server to accomplish the reception, management, processing, transmission and presentation of patient data, medical records data, medical care codes data and forms data is now enabled.

The server has loaded the client node browser window with an interactive form derived from digital format data. The form is interactive in that: (1) the user may access certain fields or records of the form and change the data content of the field or record; and (2) the newly changed data can be transmitted back to the server and processed. The user may now enter data into the interactive screen. An input device is used for entering data into the browser application. Data entry can be achieved by any of the following: computer keyboard, computer mouse, touch-screen attached to the viewing device described above, automatic voice transcription systems, and other mechanisms capable of accomplishing the purpose of an input device, e.g. light pen, or another data device.

When the user “signs” the screen form, the data currently on the screen form is transmitted to the server. The security filter or module checks the data entered into the signature block of the screen form to verify that it was the user that “signed” the screen form. If this filter is passed, the data received from the client node is processed by the host/server software, and the database is updated as appropriate. Updating is the process of adding new data to the database. Existing data in the database is not modifiable, except at the highest system security level.

Finally, a hardcopy of the screen form presentation of the digital format as presented in the browser window is printed out using the print function of the client side browser application. This step provides the printed, electronically documented medical billing and record form of the present invention.

### BRIEF DESCRIPTION OF THE DRAWINGS

FIG. 1 is a block diagram showing the primary hardware configuration of the present invention and various types of types of connectivity between them.

FIG. 2 is a block diagram of the server's primary software modules showing the hierarchy of their inter relationships and connectivity to the client side software outside of the server.

FIG. 3 is a combination block diagram showing a general overview of the major steps and corresponding software functions of the process of the present invention.

FIG. 4 shows an example of the views at a client node displaying a browser screen generated by a client side browser application. In the window of the browser screen is a presentation of a set of digital format data that displays an interactive forms template, in this case, a log-in template.

FIG. 5 is an example of digital forms data for an initial interactive forms window, presented in the window of a client side browser application screen.

FIG. 6 is an example of digital forms data coding an interactive form for a blank patient record form, presented in the window of a client side browser application screen.

FIG. 7 is an example of the form in FIG. 6 wherein the digital forms data coding the interactive form included an initial set of data loaded into the corresponding data fields when the interactive form template was presented in the window of the client side browser application.

FIGS. 8A to 8C and 9 are examples of an interactive forms template presented in a browser window, either blank (9) or pre-loaded (8A to 8C) with data, after a request for such was made by a user.

FIG. 10A is a flow diagram of the interactive system of the present invention illustrating an example of how the initialization step of the process maybe accomplished including how a specific screen form is selected in response to a specific user's login.

FIG. 10B is a flow diagram of the interactive system of the present invention illustrating an example of how the user's screen form is initially filled in from the database.

FIG. 10C is a flow diagram of the system of the present invention illustrating an example of how a user can change the screen form displayed in the browser window on the user's viewer to view data from the patients record on a different screen form, possibly loaded with different data, and showing alternative locations for the security filter function.

FIG. 10D is a block diagram of the present system illustrating how a user can output a hardcopy document of the form shown on the screen of the user station's browser window.

FIG. 10E is a flow diagram of the system of the present invention illustrating an example of how the database updating step of the process may be accomplished.

FIG. 11 is a schematic representation of the exemplary information contained in a hypothetical database, and how it is displayable or printable as a variety of different formats as forms and notes, which may be used as a hospital's or physician's individual clinic, progress, admission, billing or similar form.

FIG. 12 shows a schematic representation of an exemplary security hierarchy, which allows specific users appropriate levels and scope of access to the information contained in the database and to the database itself.

FIGS. 13A-D show examples of the views at a client node displaying a browser screen generated by a client side browser application. In the window of the browser screen is a presentation of a set of digital format data that displays an interactive forms template, in this case, the administrator's initial set-up templates.

FIG. 14 shows another example of the log-in template of FIG. 2.

FIG. 15 shows an example of the view at a client node displaying a browser screen generated by a client side browser application. In the window of the browser screen is a presentation of a set of digital format data that displays an interactive forms template, in this case, a chart rack.

FIGS. 16A-16AF show examples of the views at a client node displaying a browser screen generated by a client side browser application. In the window of the browser screen is a presentation of a set of digital format data that displays an interactive forms template, in this case, the detailed tabulation of the chart rack.

FIG. 17 shows an example of the views at a client node displaying a browser screen generated by a client side browser application. In the window of the browser screen is a presentation of a set of digital format data that displays an interactive forms template, in this case, the edit physician interface.

FIG. 18 shows an example of the views at a client node displaying a browser screen generated by a client side browser application. In the window of the browser screen is a presentation of a set of digital format data that displays an interactive forms template, in this case, the edit facility interface.

FIG. 19 shows an example of the views at a client node displaying a browser screen generated by a client side browser application. In the window of the browser screen is a presentation of a set of digital format data that displays an interactive forms template, in this case, the preferences interface.

FIG. 20 shows an example of the views at a client node displaying a browser screen generated by a client side browser application. In the window of the browser screen is a presentation of a set of digital format data that displays an interactive forms template, in this case, the history interface.

FIG. 21 shows an example of the views at a client node displaying a browser screen generated by a client side browser application. In the window of the browser screen is a presentation of a set of digital format data that displays an interactive forms template, in this case, the review of systems interface.

FIG. 22 shows an example of the views at a client node displaying a browser screen generated by a client side browser application. In the window of the browser screen is a presentation of a set of digital format data that displays an interactive forms template, in this case, the list of commonly prescribed medications by the practitioner interface.

FIG. 23 shows an example of the views at a client node displaying a browser screen generated by a client side browser application. In the window of the browser screen is a presentation of a set of digital format data that displays an interactive forms template, in this case, the physical exam interface.

FIG. 24 shows an example of the views at a client node displaying a browser screen generated by a client side browser application. In the window of the browser screen is a presentation of a set of digital format data that displays an interactive forms template, in this case, the procedure notes interface.

FIG. 25 shows an example of the views at a client node displaying a browser screen generated by a client side browser application. In the window of the browser screen is a presentation of a set of digital format data that displays an interactive forms template, in this case, the other documents template.

FIG. 26 shows an example of the views at a client node displaying a browser screen generated by a client side browser application. In the window of the browser screen is a presentation of a set of digital format data that displays an interactive forms template, in this case, the archived notes template.

FIGS. 27-29 show representative examples of a selectable forms for hard copy output of the chart.

FIG. 30 shows an example of the views at a client node displaying a browser screen generated by a client side browser application. In the window of the browser screen is a presentation of a set of digital format data that displays an interactive forms template, in this case, the archive button.

FIG. 31 shows an example of the views at a client node displaying a browser screen generated by a client side browser application. In the window of the browser screen is a presentation of a set of digital format data that displays an interactive forms template, in this case, the review prescriptions template.

FIG. 32 shows an example of the views at a client node displaying a browser screen generated by a client side browser application. In the window of the browser screen is a presentation of a set of digital format data that displays a completed form, in this case, a list of prescriptions.

FIG. 33 shows an example of the views at a client node displaying a browser screen generated by a client side browser application. In the window of the browser screen is a presentation of a set of digital format data that displays a completed form, in this case, prescription labels.

### DETAILED DESCRIPTION OF THE INVENTION

Referring now to the drawings, the details of preferred embodiments of the present invention are graphically and schematically illustrated. Like elements in the drawings will be represented by like numbers, and similar elements will be represented by like numbers with a different lower case letter suffix.

The present invention is a system for generating hardcopies of electronically documented medical billing and/or record forms. The electronically documented forms are generated from form templates and substantive data taken from a database internal to the present system. The substantive data has been verified by a care giver before entry into the database, and the data and the entering care giver are documented in the database.

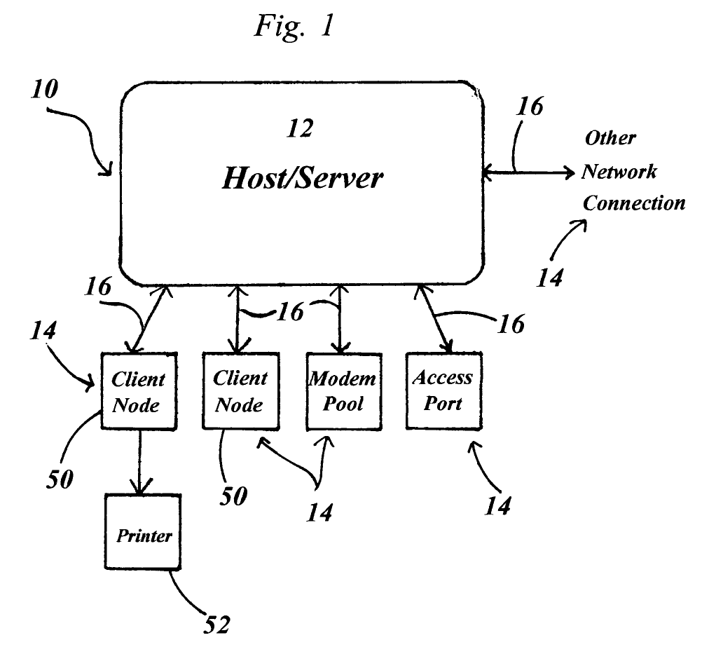

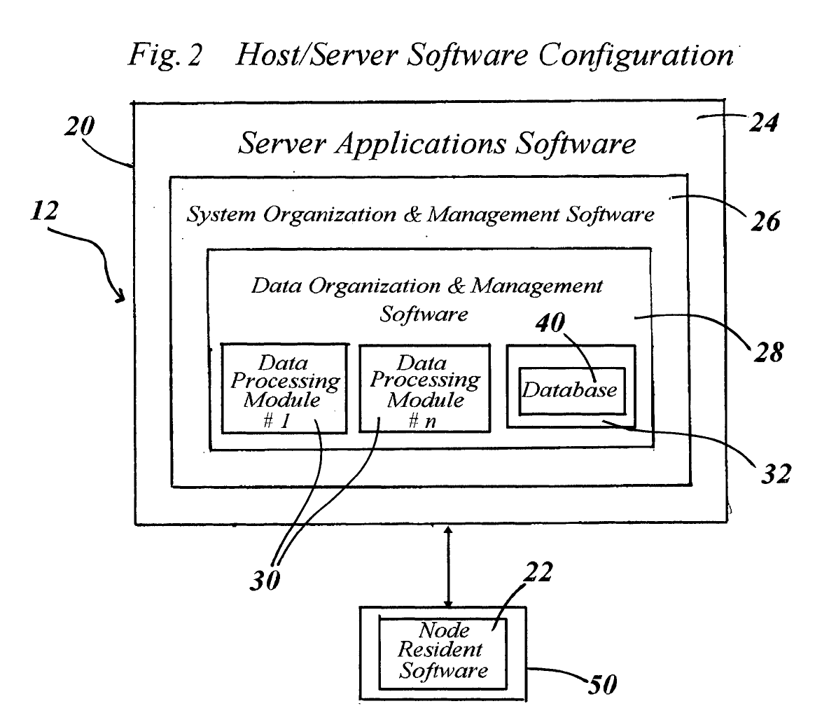

As shown in FIG. 1, the present invention comprises a client/server communications network 10 that interfaces a dedicated host/server 12 with all of the nodes 14 on the client/server communications network 10. The dedicated host/server 12 is connected to the client/server network 10 to provide for controlling the client/server communications network 10, and for processing and storing data. As shown in FIG. 2, software 20 is resident on the host/server 12 for receiving, managing, processing and transmitting patient data, medical records data, billing data, medical care codes data and forms data for accomplishing the printed forms in a digital format, and for managing a database. A database 40 is also resident on the host/server 12 for storing data. At least one client node 14 is also connected to the client/server communications network 10. Also, at least one of the nodes 14 connected to the client/server communications network 10 is a client node 50 (see FIG. 1), which supports and operates a client side browser application for presenting screen template, substantive content and other data received from the server 12 in a window of the browser application. In a preferred embodiment, the client node 50 is interfaced with a printer 52 for implementing a print function of the client side browser application to generate a printout of the digital format presented in the browser window as a printed form.

As shown in FIG. 1, the client/server communications network 10 is an arrangement comprising the dedicated host/server 12 interconnecting all nodes 14, supporting hardware such as hubs, routers and switches (not shown), and (server resident and client side) software. The client/server communications network 10 interfaces the dedicated host/server 12 with all of the nodes 14 on the network 10. The communications network 10 is an arrangement of interfaces or connections 16 which provide transmission or communications channels connecting the dedicated host/server 12 with all nodes 14, and with supporting hardware and software 20 in the system. Examples of the types of connections 16 which interface the host/server 12 with various nodes 14 include: hard wired connections, wireless connections, networked connections and switched (modem or telephone) connections.

The host/server 12 is the main computer in the client/server communications network 10, and is “dedicated” in that it is not shared by any other nodes 14 outside the network 10. The dedicated host/server 12 is connected to the client/server network and controls all operations of the client/server communications network 10, and processes and stores data in the database 40. The computer system of the dedicated host/server 12 can be a microcomputer, a minicomputer or a mainframe computer. Examples of computers that are practicable as the dedicated server 12 of the present invention include any of the server-class products commercially available from Hewlett Packard, Compaq, Sun, IBM and Apple. Mainframe computers practicable as the dedicated server 12 are available from IBM, Control Data and Amdahl. One of ordinary skill in the art, the present teachings and figures in hand, can readily select a computer system and practice it as the host/server 12 of the present invention without undue experimentation.

FIG. 2 illustrates an example of the various software applications and modules practiced in the present invention, and their interrelationship. System software 20 is resident on the host/server 12. Client side software 22 is resident on the client node 50. System software 20 includes client/server protocols for operating the present system in the usual manner of client/server networks, and for the specific functions of the present invention as well. In addition to the usual operating system software for the operation of a server (not shown), the system software 20 further comprises server applications software 24, system organization and management software 26, data organization and management software 28, data processing software 30, database management software 32, and the database 40 itself for the practice of the present system.

The server applications software 24 provides for the overall receiving, managing, processing and transmitting of data specific to the present invention. An important function of the system software 20 is to create and transmit digital format data that presents an interactive form for presentation in the window of a client side software application 22 at a client node 50. The system organization & management software 26 provides the organization, routing, management and control functions of the present system's operations, including access control and system security. An example of a commercially available software application useful as part of the server applications software 26 for accomplishing this function is MS IIS (Internet Information Server). The system management software 26 controls and manages the flow of system data within the host/server 12. For example, data received by the server applications software 24 is routed by the management software 26 functions to a location in the overall software 20 for its further processing. The internet applications software residing on the server 12 manages access to management software 28 by client browsers 22, and also manages interfaces with databases 40 via the database management module 32. It may also provide access to security software for client validation. The kinds of data the management software 26 manages within the server 12 includes patient data, medical records data, billing data, medical care codes data, forms data for accomplishing the printed forms and access security data. Access security data is utilized in the log in function to validate a user's access to the system and identifies the user's initial permission set.

The organization and management software 28 provides for database security and user management software for controlling access to the network 10, data processing functions 30 of the system, and access to the databases 40. Security is an integral part of the system. Access and presentation of data is granted to users based on their access levels. For example, if the user is a care provider, their area of practice and their security level defines which forms screen are presented to them in the browser window. Security functions are supported by a database program whose function is to define a permission set which determines a user's level of clearance. See Table I.

TABLE I
Security Hierarchy

| LEVEL: | ACCESS: | SCOPE: | ACTION: |
|---|---|---|---|
| 1a | Specific class of | Specific areas of a | View only; Able to |
| | documents | document | output |
| 1b | Specific class of | Specific areas of a | Able to update |
| | documents | document | selected |
| | | | information; Able |
| | | | to output |
| 2a | Specific class of | Able to view entire | View only |
| | documents | document | |
| 2b | All documents | Able to view entire | Able to update |
| | | document | selected |
| | | | information; Able |
| | | | to output |
| 3a | All documents | Specific areas of | View only; Able to |
| | | document | output |
| 3b | All documents | Able to view entire | Able to update; |
| | | document | Able to output |
| 4 | All documents | Able to view entire | Able to change; |
| | | document | Able to output |

Security module controls various levels of: access+scope+action
Access=what documents can a user access
Scope=how much of a document can a user view
Action=how much of a document can a user act on
Document=a patient's record

Processing modules 30 are software components of the system software 20 that manipulate or act upon data within the host/server 12 to accomplish a specific or related group of functions. Processing modules 30 are not necessarily wholly located within any discrete level of the system software 20 hierarchy shown in FIG. 2. as any component of the system software 20 may have features that extend beyond the hierarchical level shown.

The database management software 32 comprises all the rules and the databases 40 necessary to practice the present system, including user data, patient data, forms data, billing data, care codes data, medical data and administrative data. The database 40 of the present invention is a set of interrelated files that is created and managed by the database management software module 32. The database 40 is resident on the host/server 12 and includes all of the electronically stored data in the present system. The database 40 is used to store both static and dynamic data. Dynamic data can include patient data, forms data, billing data, physician assessment data, lab data, other test and assessment data, and medical procedures data. Other more static data are stored as document files, image files, template files, application files, or other file types as appropriate for the type of data involved. Data also includes browser page formats used for entering or presenting data on a viewer as well as the data content of the browser pages. Preferably, the formatting of the browser pages is designed to be familiar to a user (e.g., a patient care provider).

As shown in FIG. 1, a node 14 is a component of the network 10 that is connected via a communications interface 16 to the host/server 12. A node 14 is the point on the network where the network interfaces with a client terminal, or computer 50 or other input/output (I/O) port or device. A client node 50 is a node 14 where a user connects to the network 10, such as at a work station, personal computer or the like. A “client” is a type of node 14, while a “user” typically is a person accessing the server via the network from a node at an applications level. A client node 50 supports and operates a client side browser application for presenting the digital format data received from the server in a window of the browser application. In addition to being a client node 50, a node 14 can be a printer, a terminal, a modem pool, an I/O port or another network, as shown in FIG. 1. Preferably, a client node 50 comprises a computer, a viewer and an interface to a printer 52. The viewer typically is a computer screen, but any other methods of viewing the content presented in the window of the browser application is likely practicable in the present system. The viewer provides for visually presenting the digital forms data generated by the server and transmitted to the browser. The viewer preferably is a cathode ray tube monitor or a liquid crystal display. However, other such appropriate display device as are known in the art. Examples of commercially available client side software 22 for accomplishing presentation of digital format data in a viewer window at a client node are: NETSCAPE and INTERNET EXPLORER. These are known as browser applications. Other browser applications are available and are practicable in the present invention by the ordinary skilled artisan.

The present invention includes a printer 52. The system software 20 transmits digital format data that presents an interactive form in the window of the browser application at a client node 50. The client node 50 is interfaced with the printer 52 for printing a hardcopy form of the digital format data presented in the browser window. When the print function of the client side browser application is selected, the printer 52 generates a printout of the digital format presented in the browser window as a hardcopy, printed form. This printed form is the electronically documented medical billing and record form of the present invention. It is preferred that content and format of the documents or forms that are printed by the present system be compatible with medical billing requirements, medical records, and other patient care forms of the user. Such forms being useful for meeting the billing and record requirements of both Medicare and non-medicare payors.

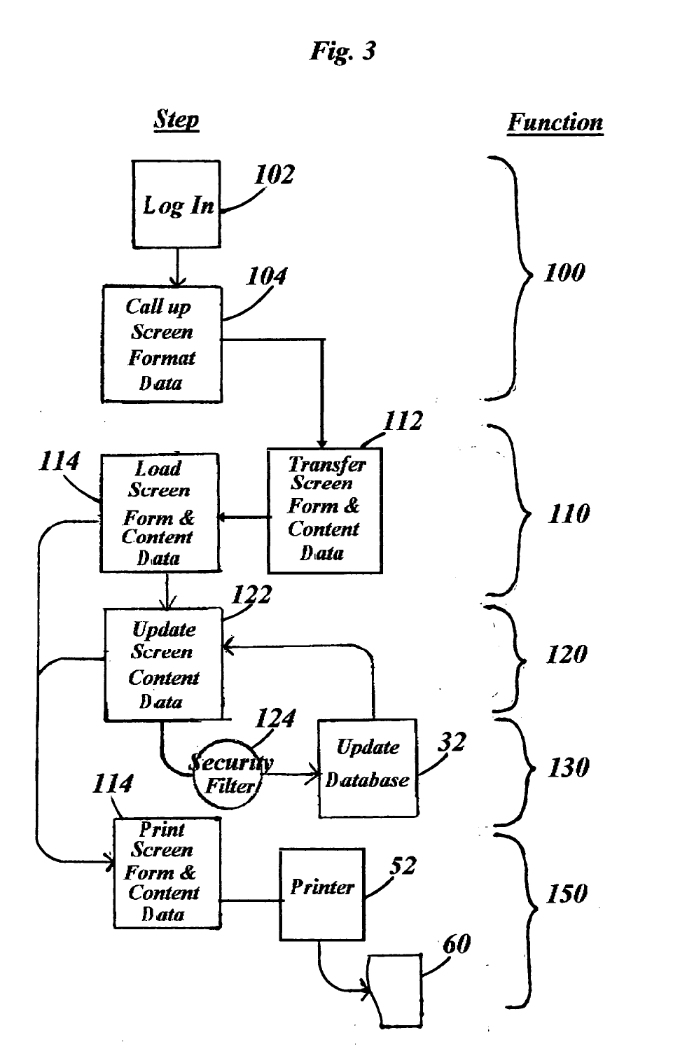

Referring to FIG. 3, the present invention includes a process for generating and printing an electronically documented medical billing and record form 60. An example of the present process generally comprises the following: providing a client/server network 10 as described herein, having a user access the host/server 12 via the network 10 from a client node 50, then transferring data between the host/server 12 and the client node 50, and printing out a hardcopy form 60 of the data transmitted to the client node 50.

In practicing the present process, a user at a client node calls up the client side browser application 22. Utilizing the browser application software 22, the user establishes communication between the client node 50 and the host/server 12 via the network 10. As shown in FIG. 3, upon initiation of communication, the host/server 12 runs a processing module 30 that comprises session initialization software 100, which includes log-in software, system access security software, user identification and tracking software, and other software components and features that communicate with a client node 50 to establish a user's access to the present system.

In practicing the present process at each start up a splash screen welcomes an individual to the software listing the software's name (MDScribble®), version and other information.

To establish a user's access to the system at the initial running of the software, initialization for establishing a designated system administrator, and granting of access to the system by individuals through submission of user identification data is required. At this time, a security level is assigned to the individual. The granting of access and delineation of privileges can later be modified or updated in the “Preferences” section as described later.

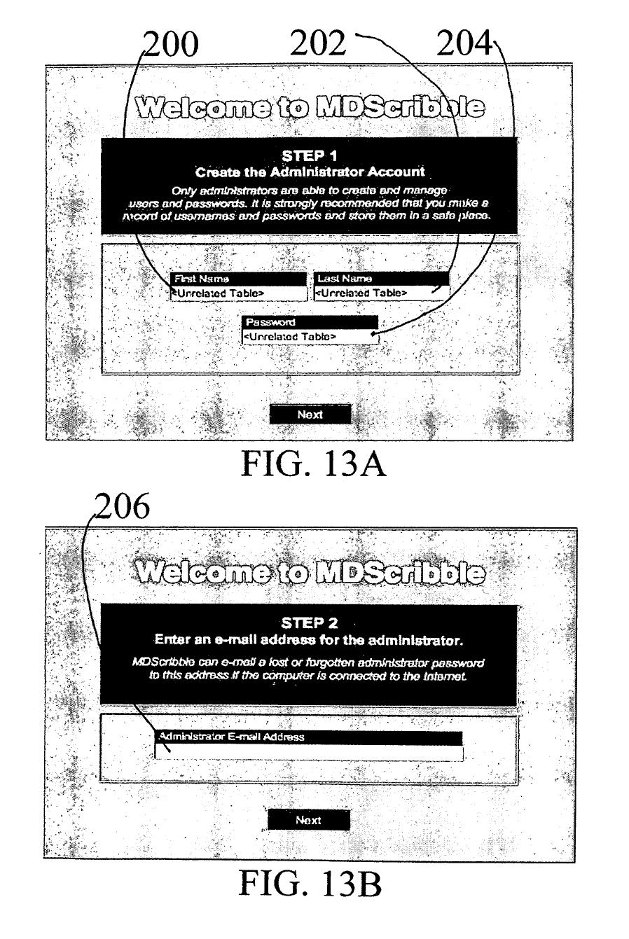

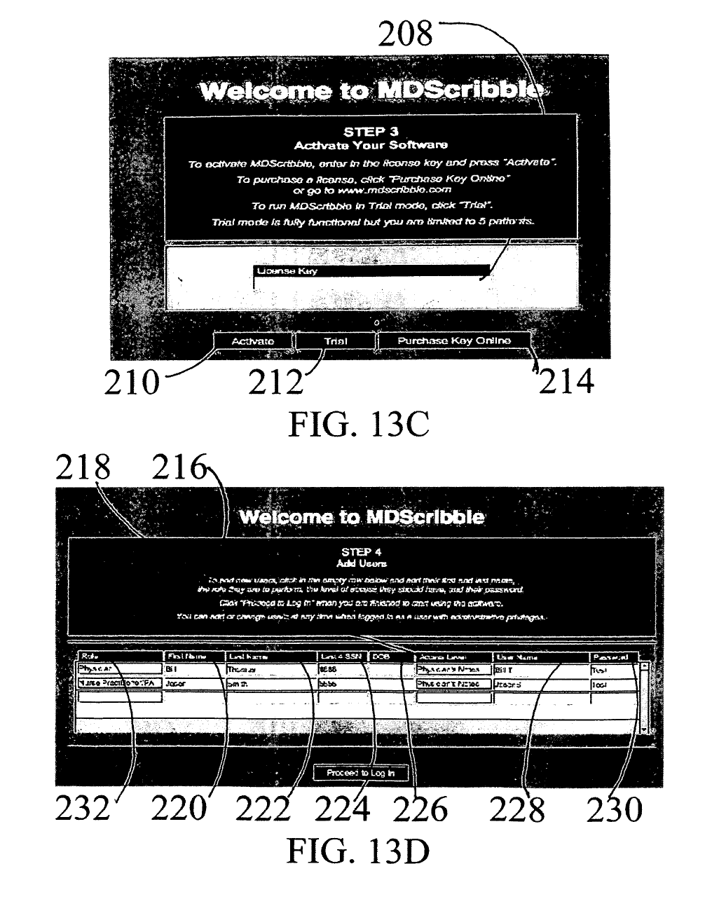

As shown in FIG. 13A, within the Administrator Account window, data may be entered including: first name 200, last name 202 and password 204. The password 204 may consist of any alphanumeric string of characters as chosen by the designated administrator.

Within a second Administrator Account window, FIG. 13B, an email address 206 for the administrator may be entered for later recovery of any forgotten passwords.

Within a third Administrator Account window, FIG. 13C, a License Key Value 208 may be entered. This number is required to active the software, and is supplied with a purchased “physical” copy of the software or “downloadable” version of the software. A License Key Value 208 is not required for trial versions.

An “Activate” button 210 runs a script that compares an entered License Key Value 208 with a value stored within the database, permitting or denying access to the software's database. A “Trial” button 212 allows a user to run a script which allows full access to the database software but limits trial use of the software to a total of five patient entries. A “Purchase Key Online” button 214 allows one with internet access to purchase a License Key Value 208 online from the MDScribble® website to “unlock” the software, converting a trial version into a fully functional version by eliminating the five patient limit.

As shown in FIG. 13D, an administrator's privilege delineation window 216 allows individuals to be added to the database, granting these individuals privileges to use some or all of the software based on their “Access Level” 218. This data can at any time be accessed by the administrator through a “Preferences” section 382 to grant new individuals access to the software, remove individual access from the software, or to modify the Access Level 218 of any individual with software privileges.

At the administrator's privilege delineation window 216 the level of software access for a specific user is established. The individual's first name 220, last name 222, last four digits of their social security number 224, a user name 228, and password 230 will be set up in this section. A level of software access will be set for the specific user. These levels are given the term “roles” 232. The role name may or may not correspond to the actual function of the individual within healthcare practice; it delineates access level within the software. The administrator does not participate in the level of software access unless the administrator adds themselves as a permitted software user.

The roles and access levels include Physician and Nurse Practitioner/Physician Assistant who have read/write access to all areas of the software. However, for the Nurse Practitioner/Physician Assistant on all final printed documentation, this individual's name will appear with the name of the overseeing (co-signing) physician's name. A Nurse role has read/write access to most areas of the software, including the nurse's notes section, but has only read access to the Physician's documentation.

The Front Desk role has read/write access to a patient's demographics section, but read-only access to the nursing and physician documentation. The Billing role has read access to all areas of the software, but no write access. The software in now initialized and ready for log-in by a designated user.

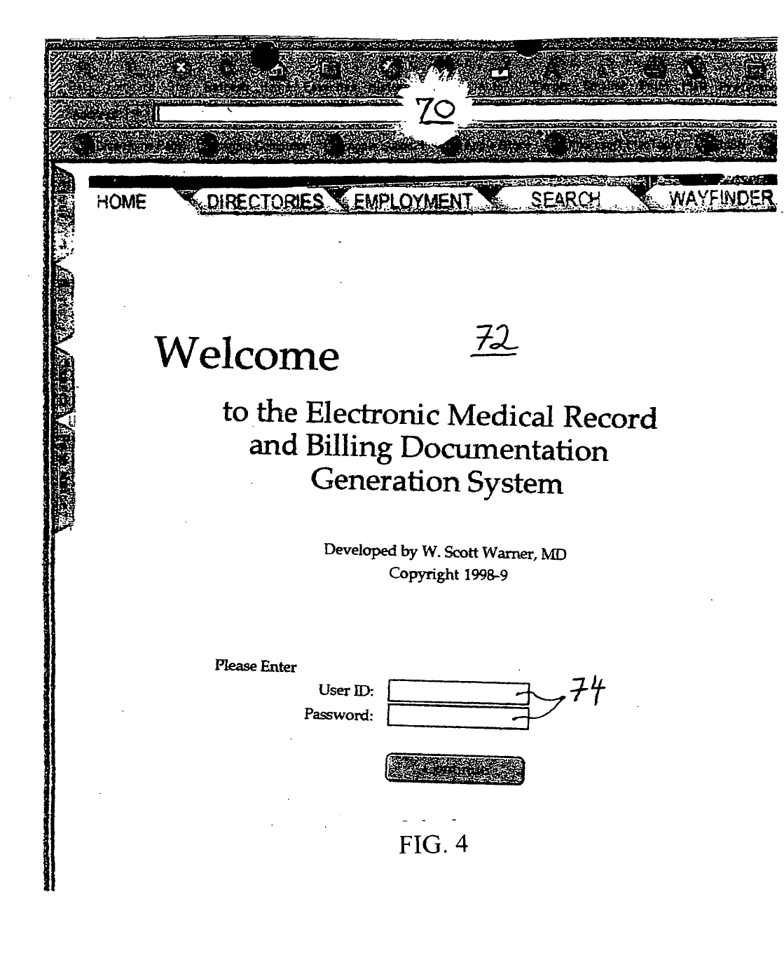

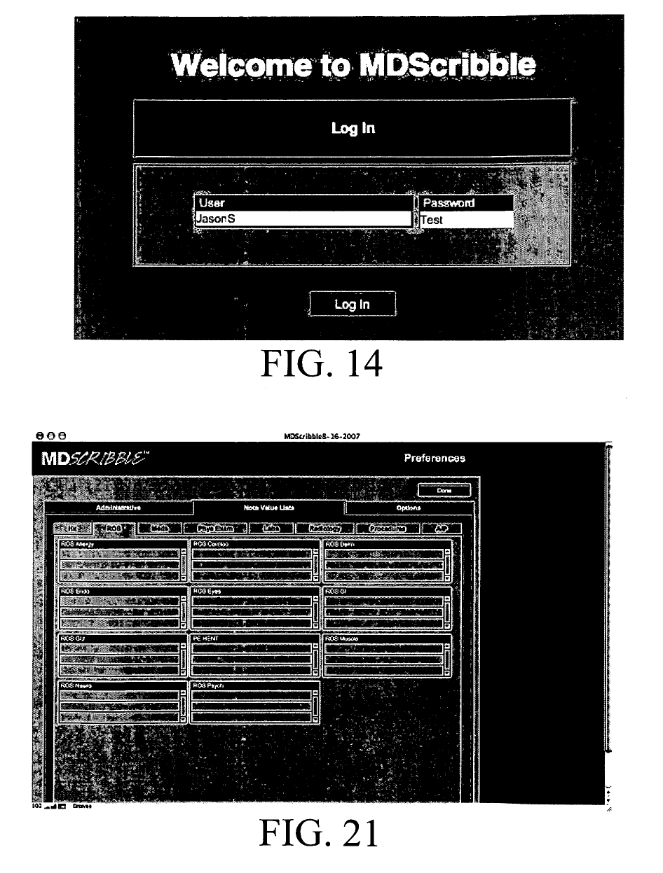

The user is now able to proceed with a log-in request. The initialization module software 100 transmits a log-in request 102 to the client node 50 that is displayed in a window of the client side browser application 22 (See FIGS. 4 and 14), and requests entry of the user's identification data. The user enters log-in data into the data fields of a forms template presented in the window of the client side browser software application 22 using an input device interfaced with the client node 50. Data entry can be achieved by any of the following input means known to the ordinary skilled artisan, including: computer keyboard, computer mouse, touch-screen attached to the viewing device described above, automatic voice transcription systems, and other mechanisms capable of accomplishing the purpose of an input device, e.g. light pen, another data device (disc, PALM PILOT-type device, etc). Other data required to be entered into the system by a user at a client node 50 is similarly entered. Upon receiving the user data, the initialization module 100 either rejects the user's log-in attempt or allows the user access to the system, based on whether the system recognizes the user's identification data. A user admitted onto the system is assigned a digital tracking tag (e.g., a user number) and a permission set by the security protocol module 124. The permission set determines the security level assigned to the user for this session (See Table I).

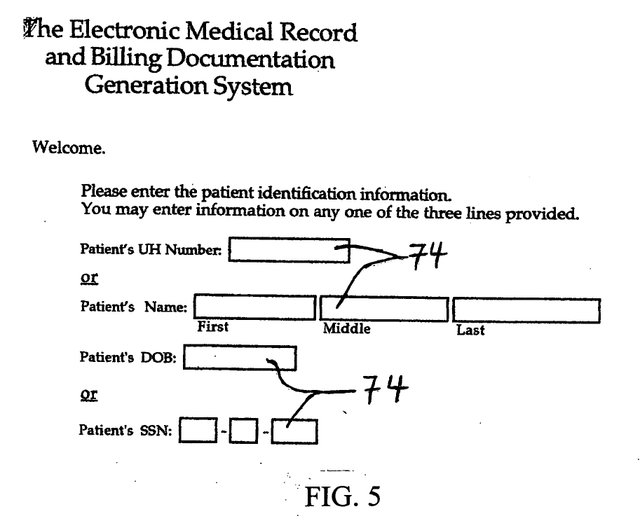

Upon receiving a valid user log-in, the host/server 12 transmits an acknowledgment back to the client node 50 to be displayed in the browser window of the client side software application 22. The acknowledgment is an initial interactive data request form template 104 (See FIG. 5). A template form is interactive in that the user may access permitted fields of the template form, input or change the data content of a permitted field, and transmit the inputted data back to the host/server 12 for processing by the system software 20. After the initial data request template 104 is presented in the window of the client side software application 22, the transfer of data between the client node 50 and the host/server 12 to accomplish the reception, management, processing, transmission and presentation of patient data, medical records data, medical care codes data and forms data is enabled. A combination of the server applications software 24 and the system management software 26 now control and track the user's session.

The client node 50 browser software 22 window is now presenting or displaying an initial interactive data request forms template 104 derived from digital format data received from the host/server's user session initialization software 100, in response to the user's log-in to the present system. This initial form may be a form specifically for this purpose, as in FIG. 5.

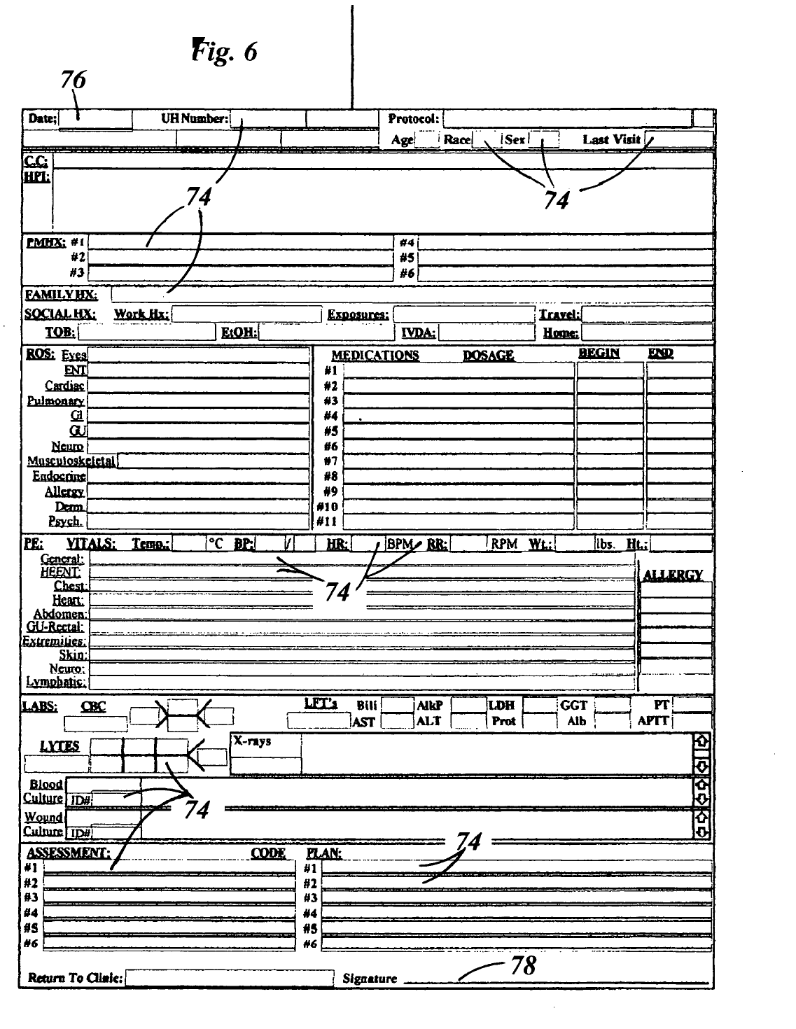

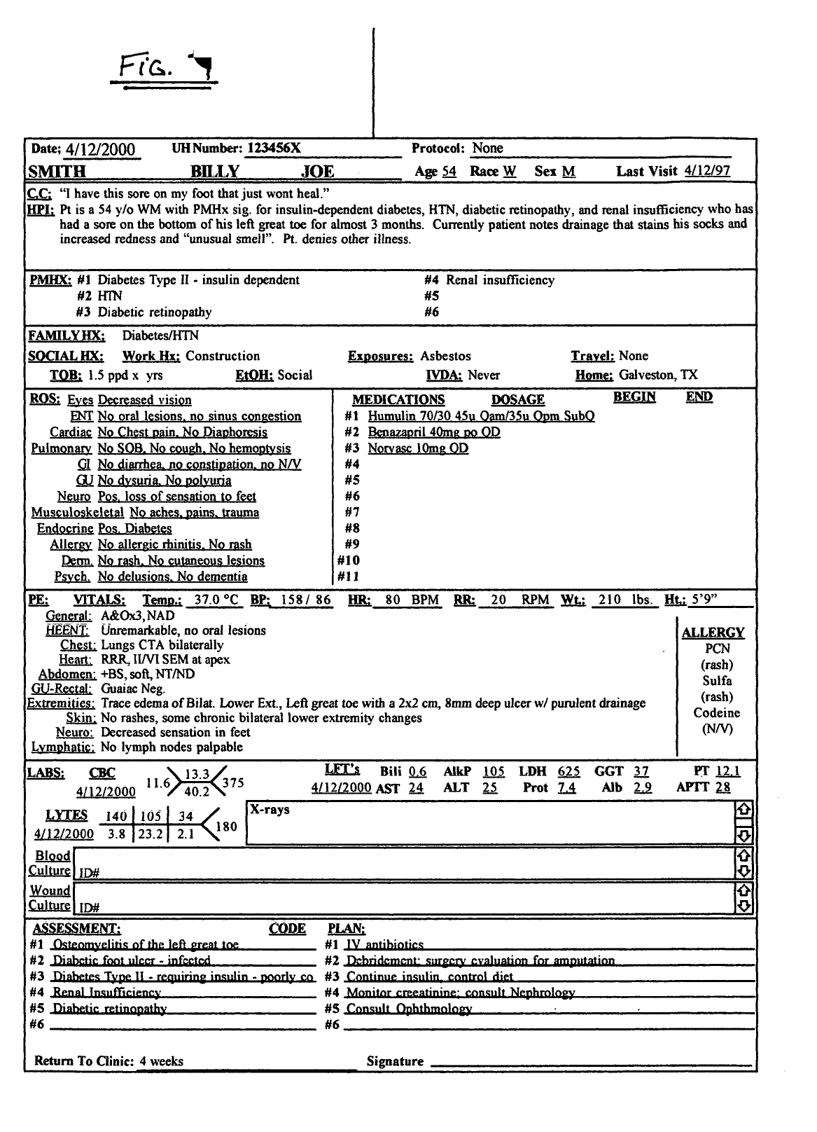

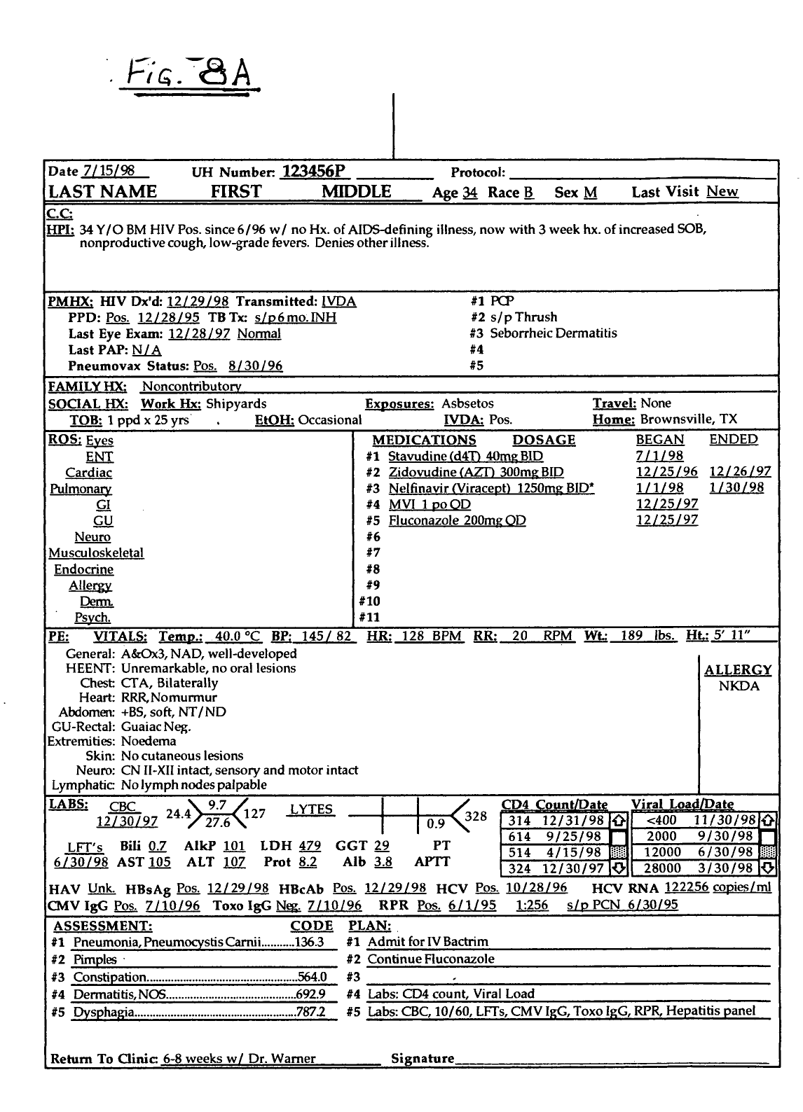

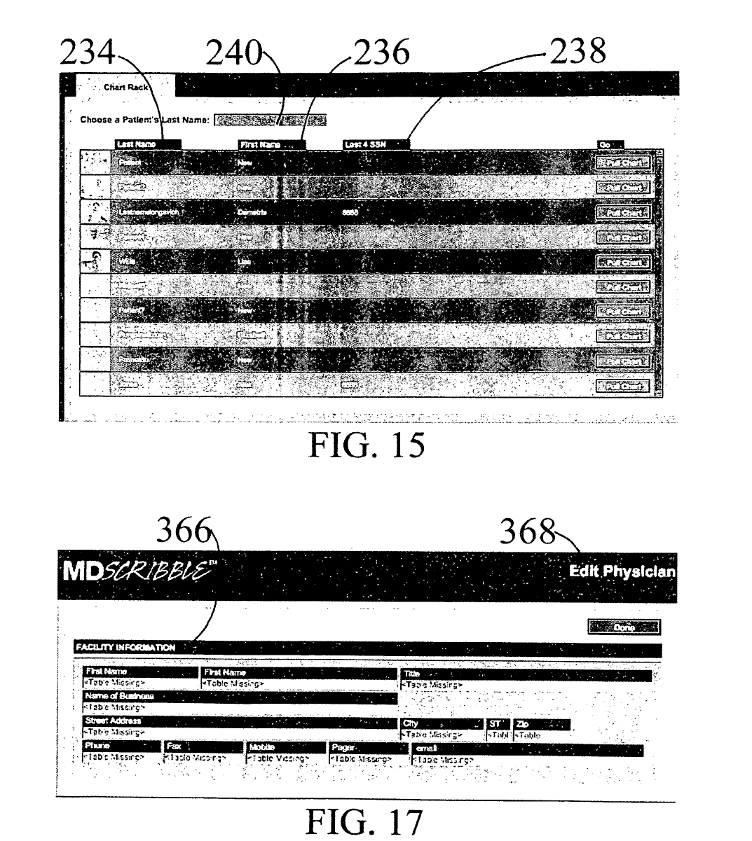

In the present preferred embodiment, FIG. 15, the template is in the form of a chart rack 104a. A list of the most recent patients whose charts are documented appears. This table may contain the patient's last name 234, first name 236, and last four digits of their social security number 238. The interface contains a search box 240 for searching for an individual's medical record (chart) where the user enters the patient's last name or other identifying information such as first name and last four digits of the social security number to access the patients chart. This search box performs active real-time narrowing of the list of patients as the letters of the last name are being entered for rapidly accessing the appropriate medical record. Alternatively, a blank form such as a patient data form (See FIG. 6) or the like may be accessed.

The software closely emulates the traditional hardcopy paper medical record to which all physicians are familiar. This includes aspects like the “chart rack” which contains all the medical records of the patients of the physician, the “chart” or medical record itself for each patient, the individual physician “notes” for that patient, and other chart sections containing other information relevant to the patient. Once logged into the software, the chart rack window 104a appears, allowing one to access or obtain a patient's medical record or chart. Once the chart is accessed, there are multiple sections within the chart which contain different types of information. These sections then contain subsections to further separate the patient's information into logical and intuitive areas that ultimately comprise an organized and very usable medical record.

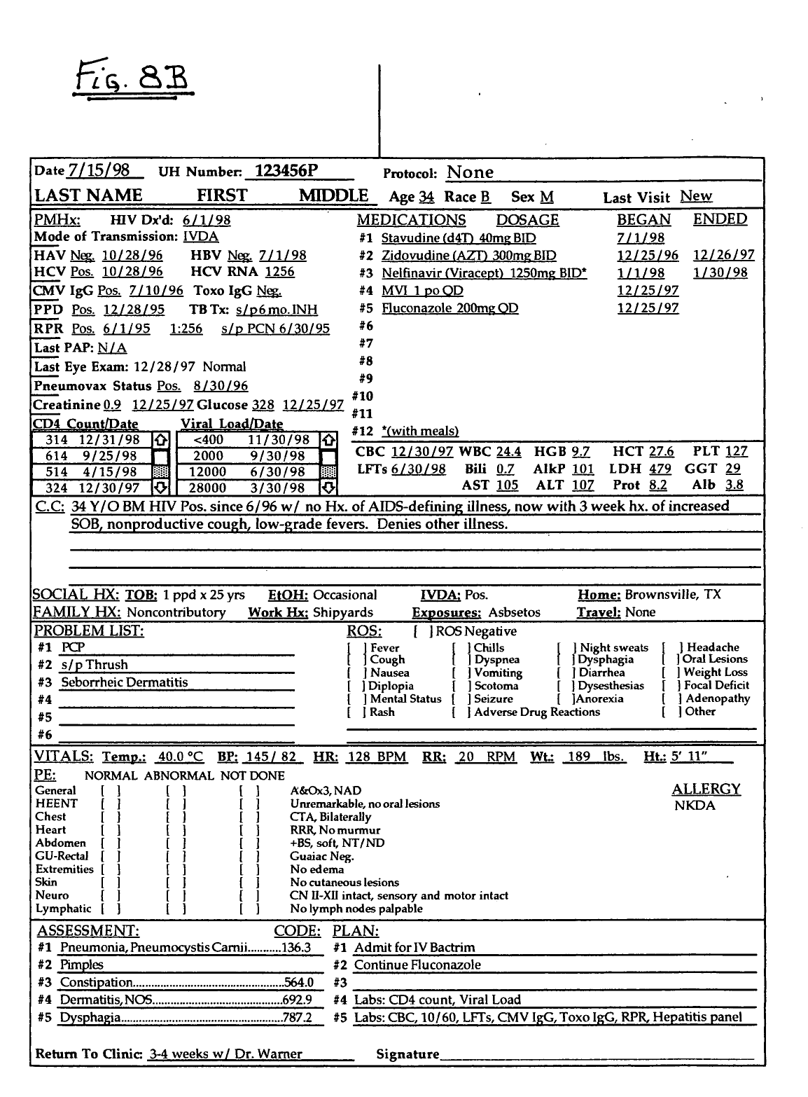

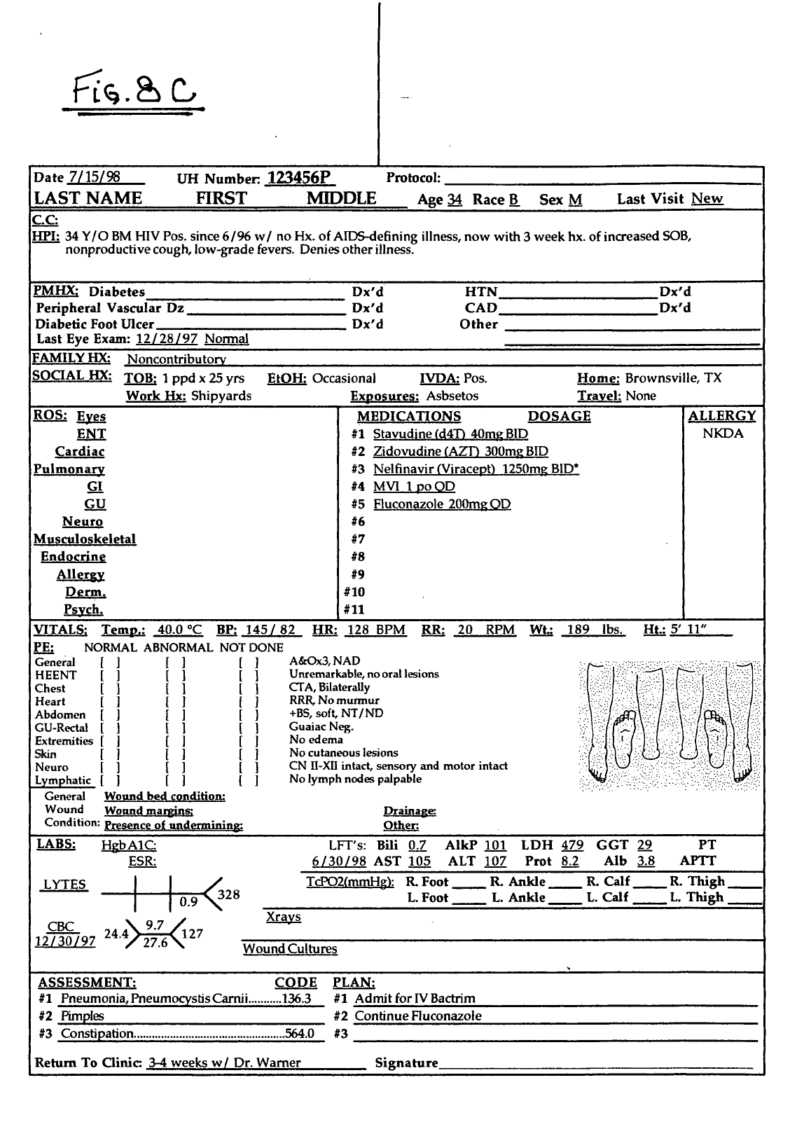

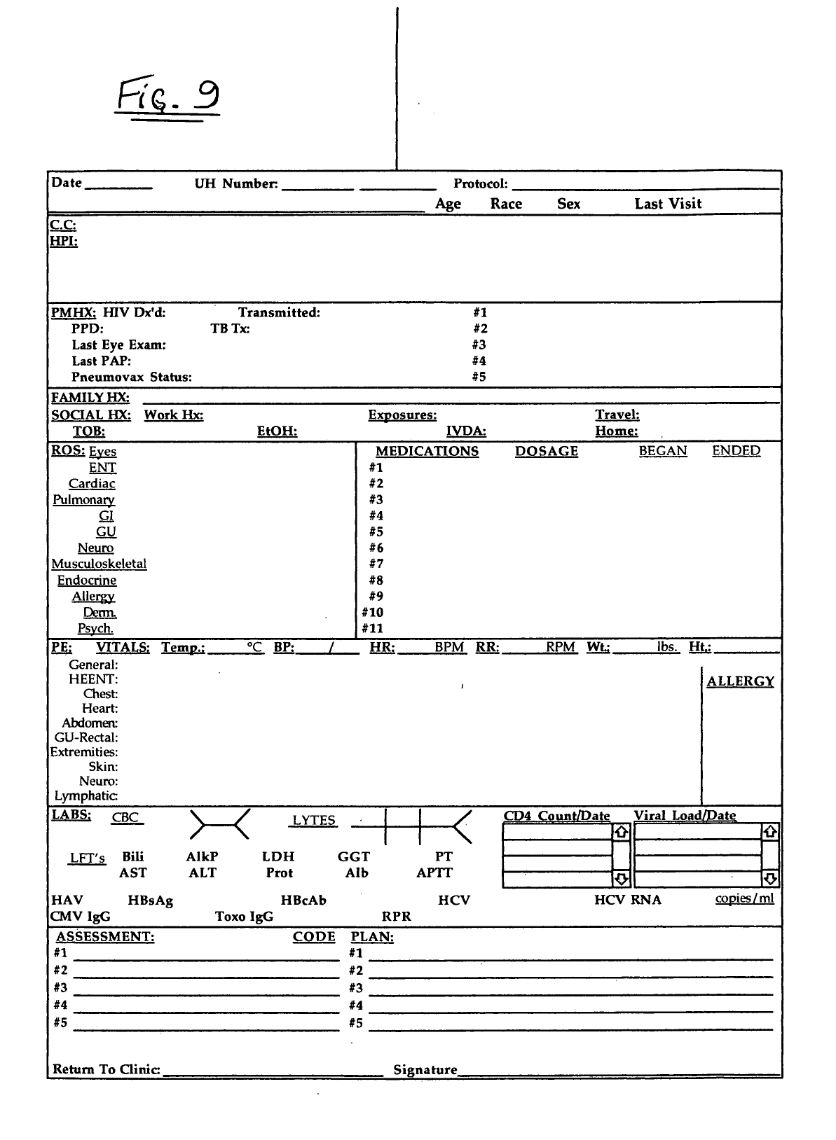

The user may now utilize the initial interactive forms window 104 to access the data retrieval module 110 of data management software 28 to retrieve forms templates and data from the database 40 to the extent allowable by the user's permission set. The data retrieval module 110 is a data processing module 30 that utilizes system software 20 components and features to retrieve data from the database 40. For example, data retrieval module 110 includes data processing module 32 to accomplish the retrieval of data from the database 40. The data acquisition module 110 access the database 40 and extracts permitted data for generating digital format data for transmission to the client node 50. The digital format data is presented in the window 72 of the client side software application 22. This is accomplished by entering the appropriate data into the corresponding data field 74 of the interactive form template and transmitting the data to the system software 20 for processing. For example, the user may initiate a session by requesting that patient data from the system database 40 or that a new forms template be presented in the window of the client side application 22. In response to the user's initial request for data, the screen data control software 112 directs the data management software 28 to provide a new set of digital forms data to be transmitted by the system software 20 to the client node 50. The new set of digital forms data presents an updated forms template 114 in the window 72 of the client side software 22. The updated forms template 114 can comprise the prior viewed forms template with new or refreshed data in the data fields 74 (See FIG. 7), or a template different from the prior viewed forms template with (See FIG. 8A to 8C) or without (See FIG. 9) data in the data field 74. A time/date stamp 76 always appears on the currently presented forms template in the window of the client side application 22. As exemplified by FIGS. 7, 8A to 8C and 9, many different templates may be practiced in the present invention to accommodate a specific user or class of user's requirements. Preferably, the forms templates are coded in a software language that is broadly accurate and uniform in its presentation in a browser window and as universally executable as possible. In the present invention, this was accomplished in two ways: 1) using a database software program whose output matched the digitally viewable template form and 2) coding the exemplary forms as PDF™ files using ADOBE™ software. Though these two mechanisms were used, other ways of achieving this goal do exist.

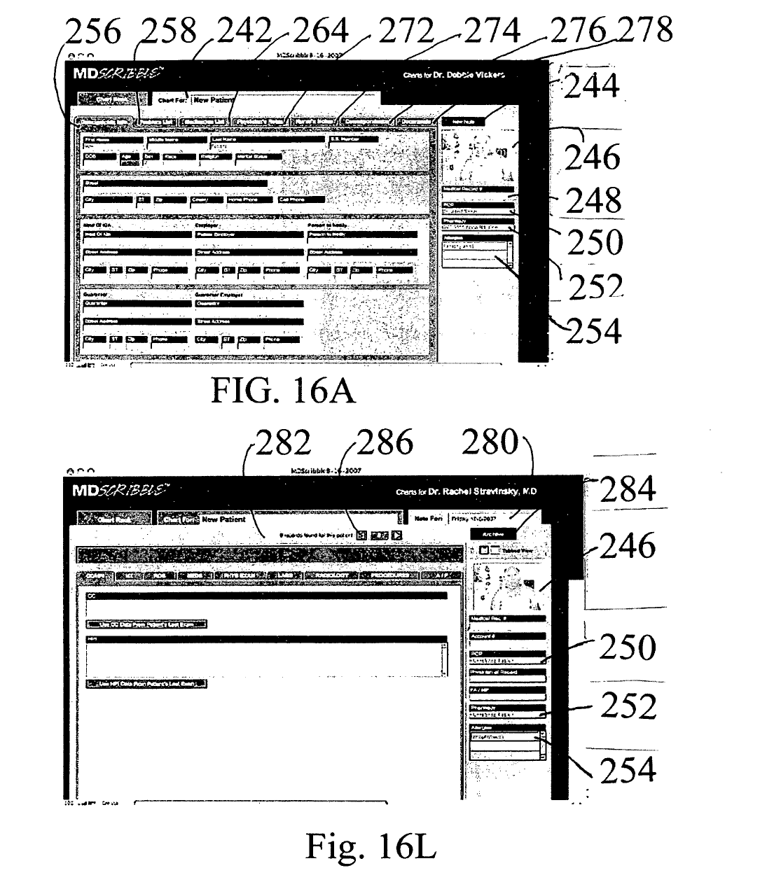

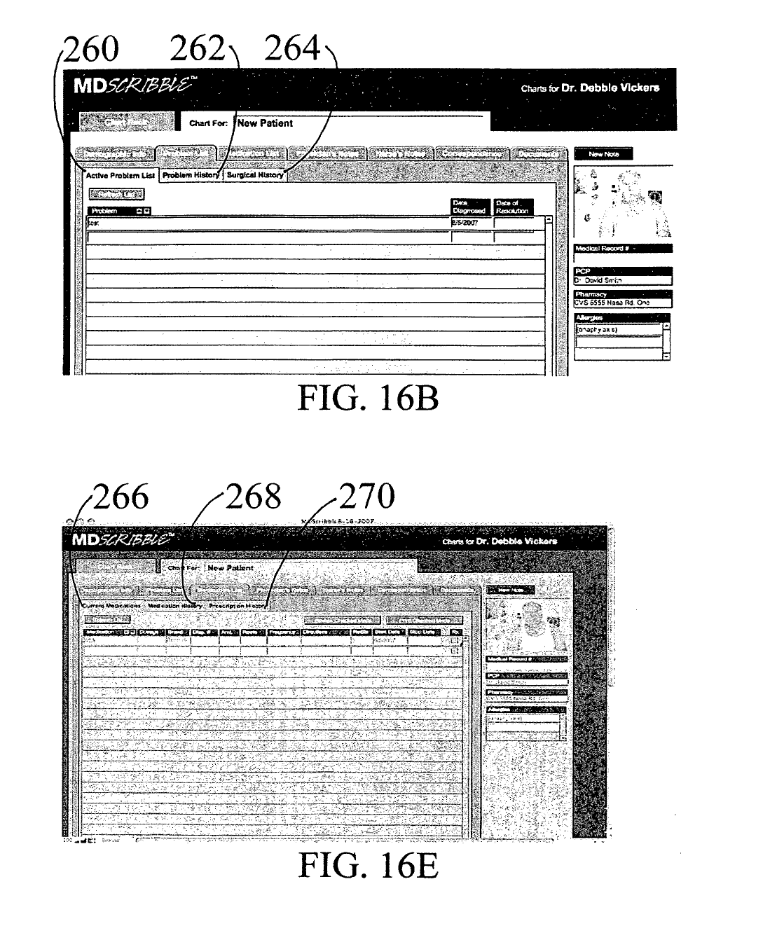

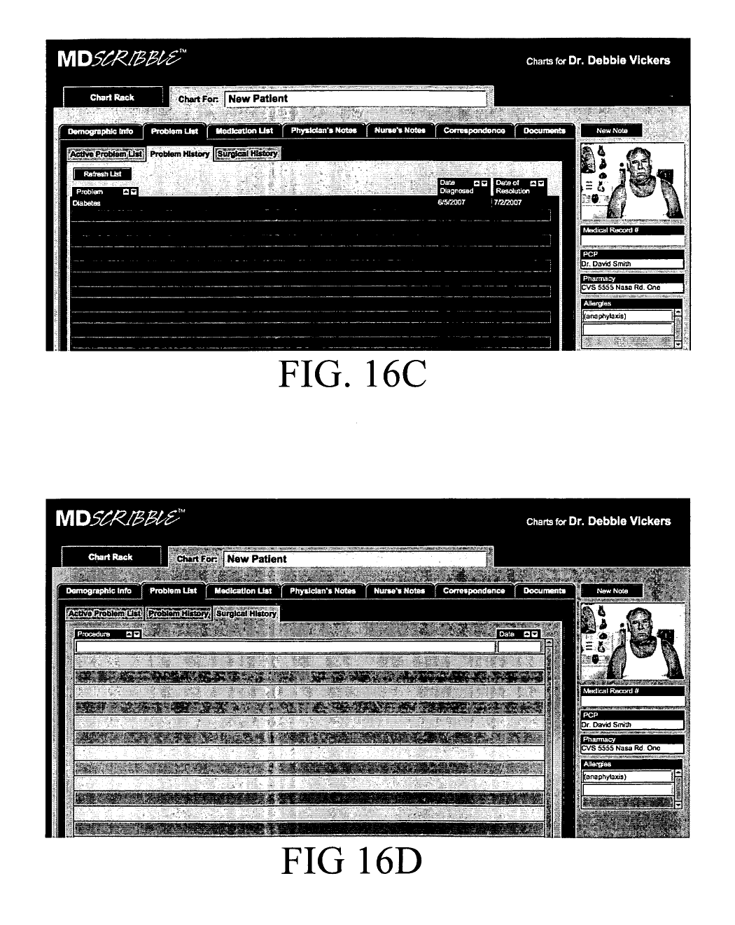

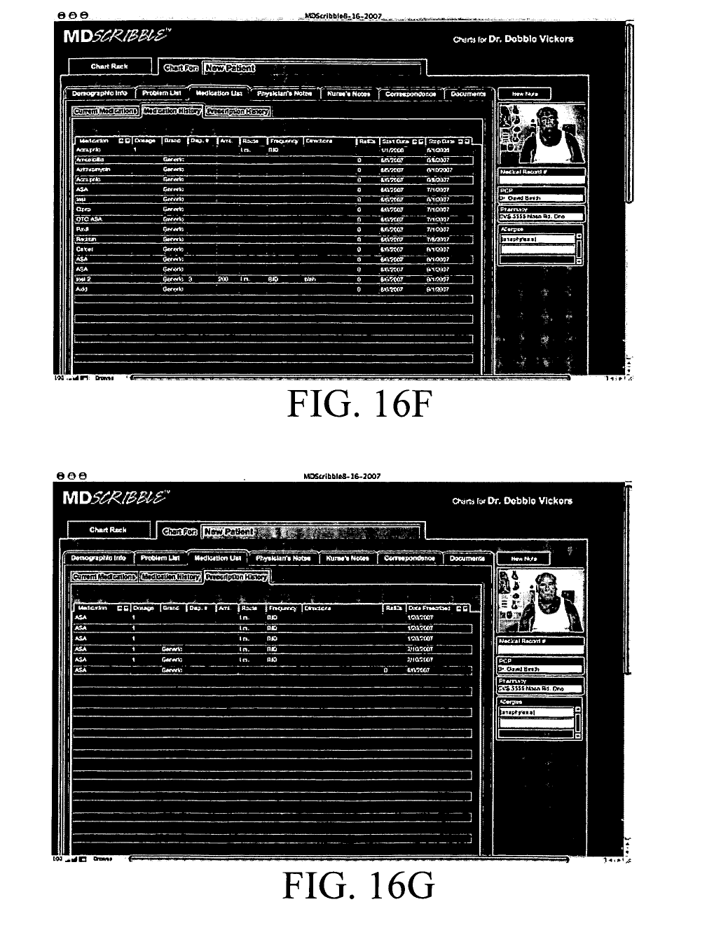

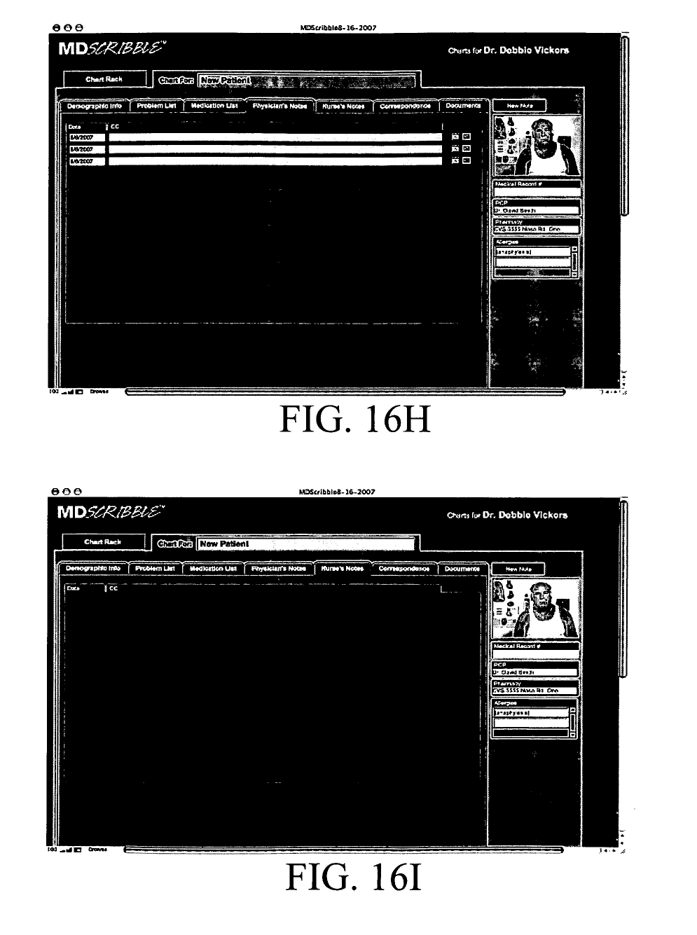

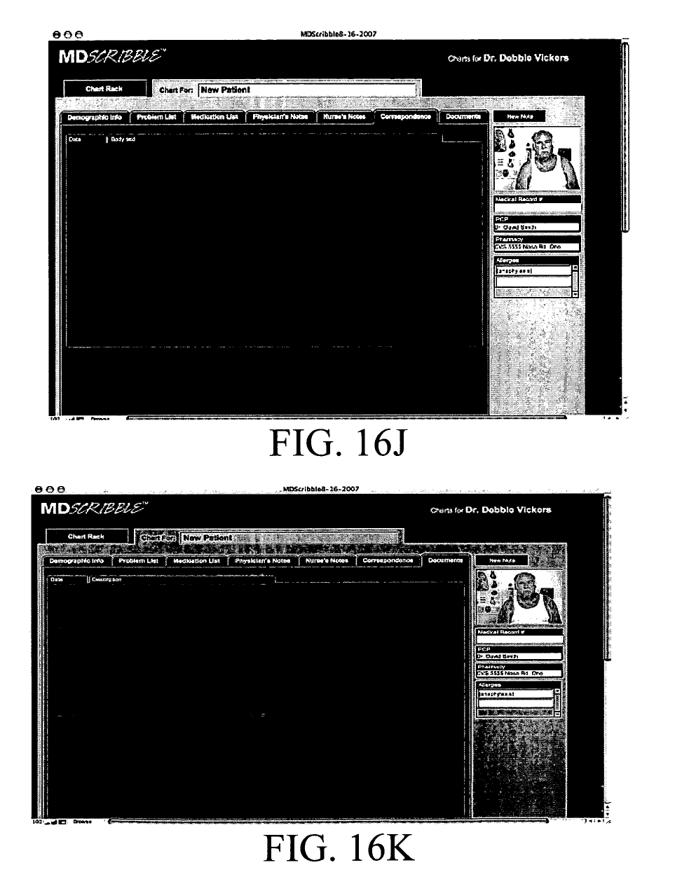

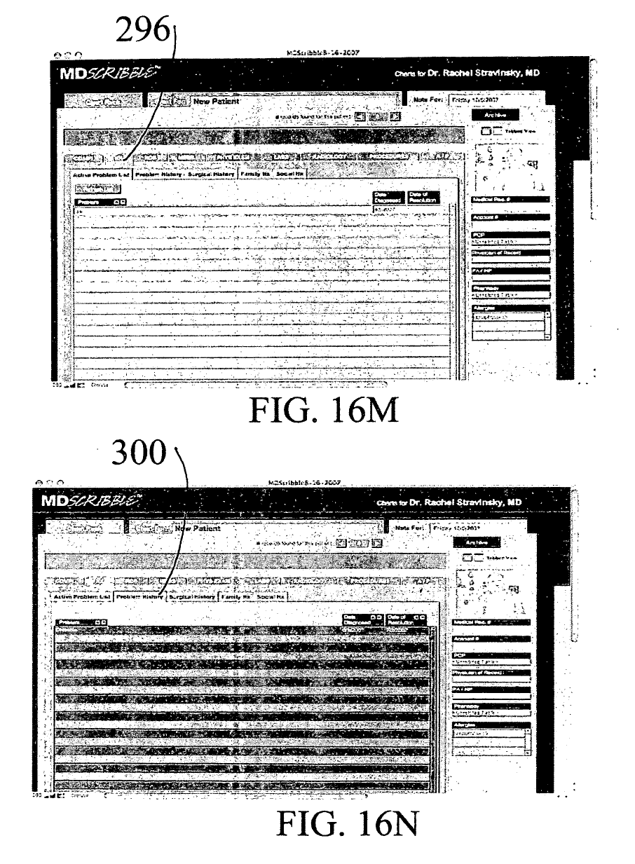

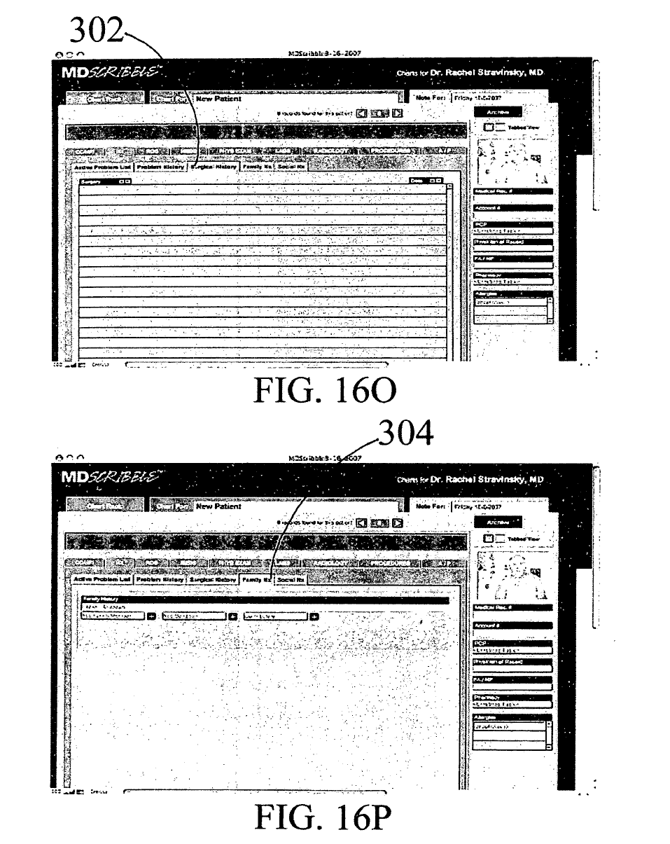

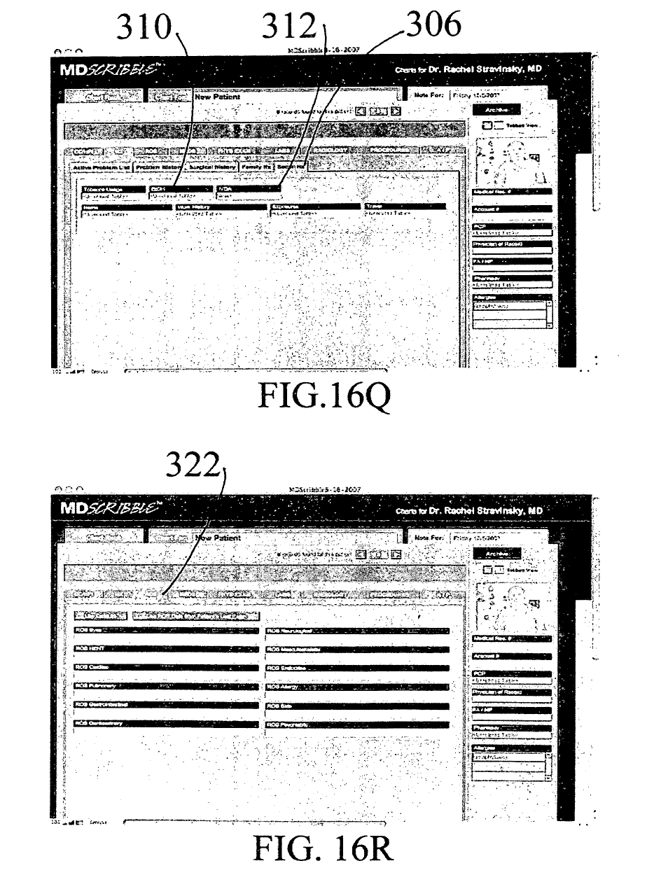

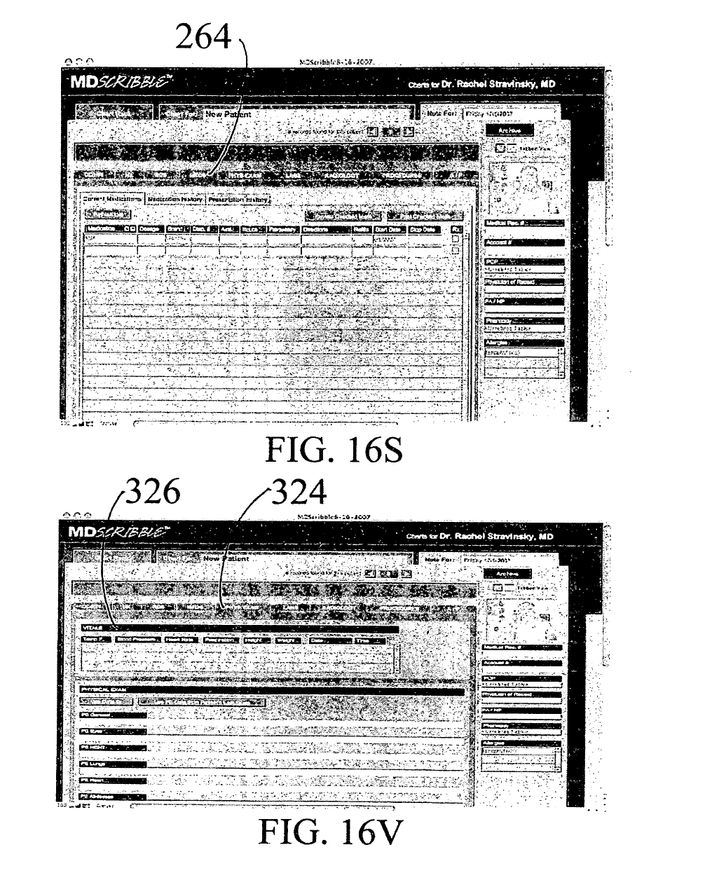

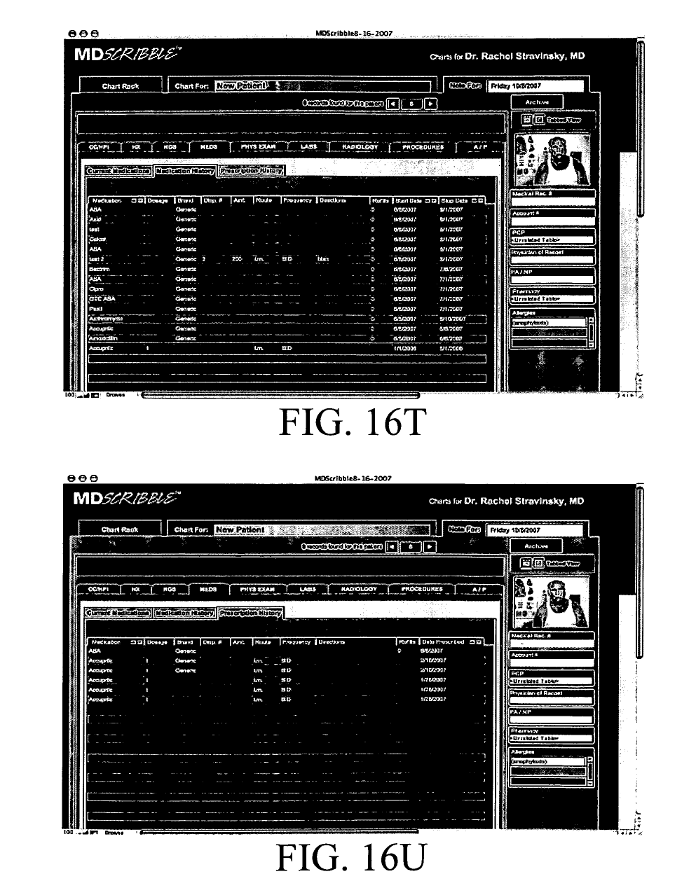

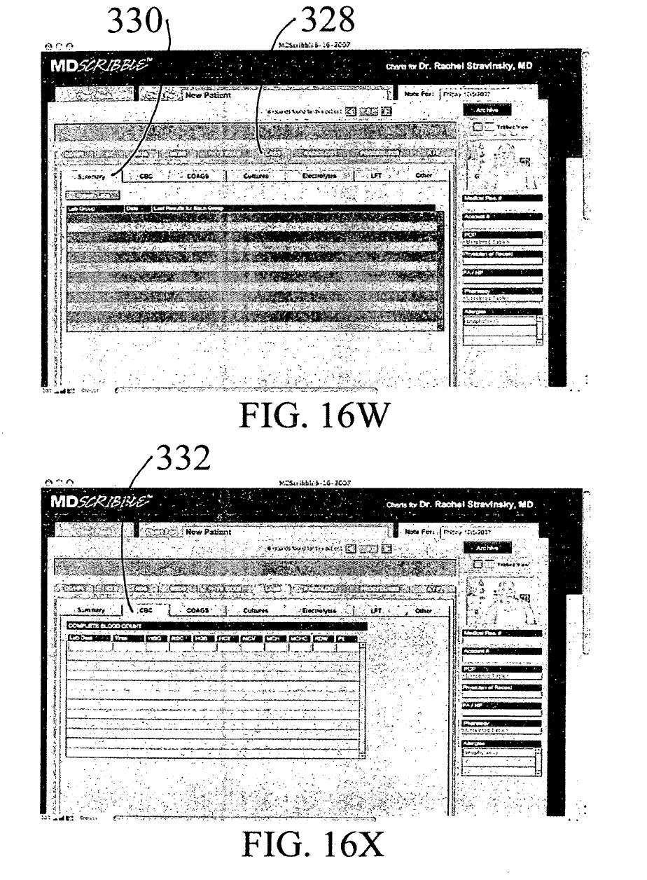

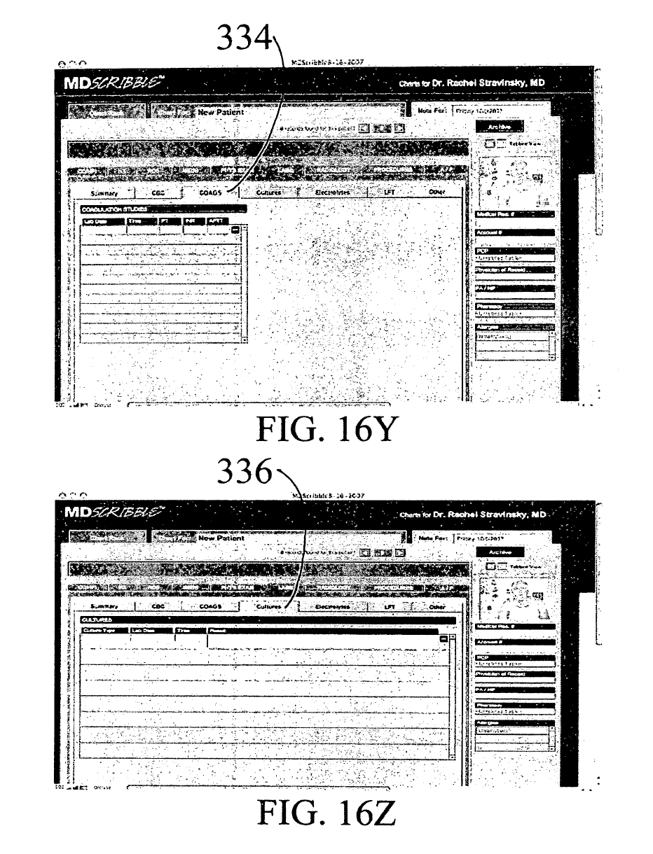

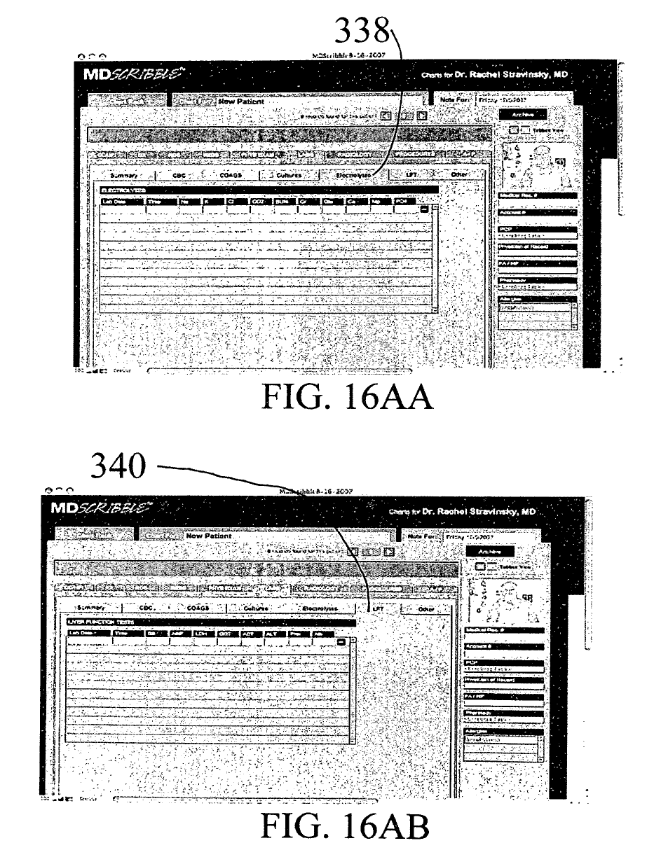

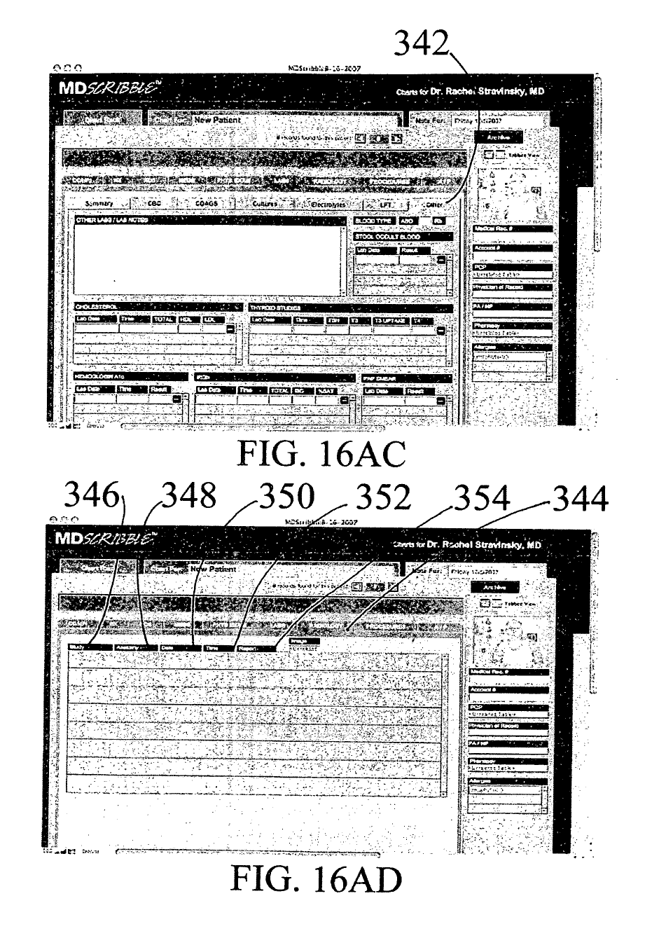

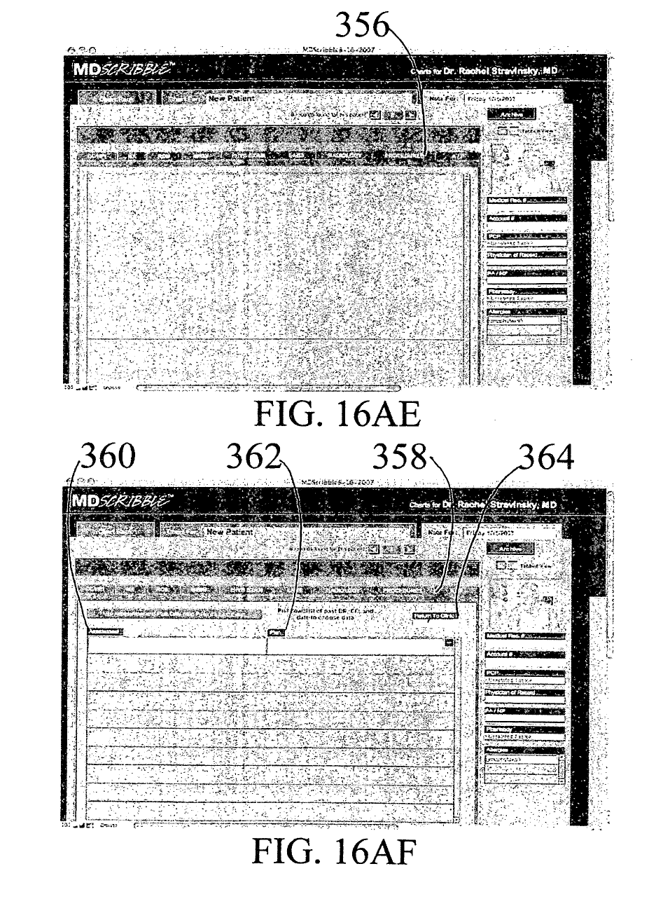

In the present preferred embodiment, different templates may be practiced in the present invention to accommodate a specific user or class of user's requirements. These embodiments are exemplified in FIGS. 16A-16AF. As shown in FIG. 16A, the chart 242 for a specific patient is shown. At the chart level of the software, there are sections of the user interface that remain relatively constant allowing the physician at-a-glance access to frequently accessed and important information such as the patient's drug allergies and primary care physician. There are variable areas of the screen tabbed to allow for input of clinical data pertinent to the patient into the database. The data in this section is only viewable when the corresponding tab has been chosen. The constant portion of the patient's medical record of the chart 242 may contain the following tabs: A “New Note” button 244 to link to the “Note” level of the software wherein data may be entered to generate a daily clinic note; Patient Identifier 246 such as a photo; Medical Record Number 248, a number assigned to a particular patient corresponding to a particular facility or practice; Patient's Primary Pharmacy 252 and Primary Care Physician (PCP) name 250. The PCP name 250 section is linked to a physician directory database that contains identifying and other information on physicians whose information has been previously inputted in the directory. This allows for the addition of a physician to the physician directory database or the choosing of a previously entered physician. It further allows for tagging a particular physician as the patient's primary care physician. The patient's primary pharmacy 252 section links to a pharmacy directory database containing identifying and other information on pharmacies previously entered into the directory. All directories may be accessed from the preferences page. Further, addition of a particular Pharmacy to the Pharmacy Directory or the choosing of a previously entered Pharmacy. Allows “tagging” a Pharmacy as the patient's primary Pharmacy. The allergy list 254 lists all medications or other compounds to which the patient is allergic in a readily viewable area. Medication names may be added.

Various aspects of patient information are contained on sub tabs of the chart 242. As shown in FIG. 16A, the Demographic Data tab 256 brings up data fields for entry of such identifying information as Patient's Name, Patient's Social Security Number, Patient's Date of Birth, Patient's Age, Patient's Sex, Patient's Race, Patient's Religion. Patient's Marital Status, Patient's Address, Patient's Next Of Kin. Patient's Employer, Person to Notify, Guarantor, Guarantor Employer, Primary Insurance Company Information and Secondary Insurance Company Information.

Another sub tab of the chart 242 is the Problem List 258 tab. Including under the Problem list 242 are three subsections: Active Problem List 260, Problem History 262, and Surgical History 264 (see FIG. 16B). The active problem list 260, contains a list of current or active conditions of a patient. These may be acute or chronic processes that may or may not require active therapy. The problem history 262 list contains a history of all conditions that the patient may have had, but are now resolved. See FIG. 16C. The surgical history list 264 contains a history of all previous surgical procedures. See FIG. 16D.

The sub tab for medication list 264 contains three subsections: Current Medications 266, Medication History 268 and Prescription History 270. See FIG. 16E.

The Current Medication 266 list contains information on all the medications that the patient is currently taking. This information includes: medication name, dosage, brand name or generic formulations of the medication, number of the medication dispensed, amount of medication to be taken at one time, route of administration, frequency or how often the medication should be taken, specific directions for taking the medication, number of refills, date prescribed (start date) and date completed (stop date). Medications in the Current Medication Section 266 will have their stop dates blank. Once a date is entered into the stop date value box, the medication is transferred to the Medication History 268. The Medication History 268 contains a list of previously taken medications with initiation (start) and completion (stop) dates. All medications listed in the Current Medication 266 list are transferred to the Medication History 268 list upon entering a completion or stop date. (FIG. 16F). The Prescription History 270 is a list of previously prescribed medications with initiation and completion dates. (FIG. 16G).

The sub tab for Physician's Notes 272 provides a list of all physician notes on a patient contained within the chart that may be sorted by date, physician, or other identifier, with links to the actual note documentation. FIG. 16H.

The sub tab for Nurse's Notes 274 provides a list of all nurse's notes on a patient contained within the chart that may be sorted by date, nurse, or other identifier, with links to the actual note documentation. FIG. 16I.

The sub tab for Correspondence 276 provides a list of all documentation generated by the software regarding a patient that may be sorted by date, physician, or other identifier, with links to the actual correspondence documentation. FIG. 16J.

The sub tab for Documents 278 provides a list of any other data that can be scanned or otherwise electronically input into the database including, but not exclusive to, scanned images, photos, or PDF files. FIG. 16K. See “Importing Digital Data or Images” below.

As an example, to generate a new Physician Note 272 for a patient visit one would choose the “New Note” button 244 found at the top of the constant portion of the patient's medical record at the chart level 242. This brings up a date window 280 within the note tab adjacent to the chart tab 242 that contains the date of the note. Like the Chart window 242, the note window 282 contains constant and variable regions. See FIG. 16L.

### Notes Windows

The constant portion of the patient's medical record at the note window 282 contains various buttons. An “Archive” button 284 freezes or creates unalterable the current database information at that particular date and time. It also eliminates the term “This Is An Active Chart” from the physician's signature line in the printable forms of the clinic note. Non-archived or “active” notes may be printed for review prior to archiving, but are indicated as such. Only archived notes may be printed in final form. Other buttons which may be included are Scroll buttons 286 to scroll through or bring to view previous notes and Patient Identifier 246; Medical Record Number 248, Patient's Primary Pharmacy 252, Primary Care Physician (PCP) name 250 and allergy list 254.

The variable portion of the patient's medical record at the Note level may contain the following: Chief Complaint/History of the Present Illness tab 290 where the patient's chief complaint may be entered into the database. See FIG. 16L. This links to a drop-down list that may be set up in the Preferences section 382 to contain default wording for those physicians who see patients with the same or similar complaints to expedite data entry into the patient's note.

Immediately under the Chief Complaint 290 data entry area is a button labeled “Use CC Data from Patient's Last Exam” 288. By pressing this button, the chief complaint documented in the patient's previous note is imported into the current note and made part of the current documentation. Once imported, the wording may be edited. This may be used for patients who are having multiple visits for the same complaint.

The data entry area “History of the Present Illness” 292 is where the history of the patient's present illness may be entered into the database. Immediately under the History of Present Illness 292 data entry area is a button labeled “Use HPI Data from Patient's Last Exam” 294. By pressing this button, the history of the present illness documented in the patient's previous note is imported into the current note and made part of the current documentation. Once imported, the wording may be edited. This may be used for patients who are having multiple visits for the same illness.

The Medical History (HX) tab 296 includes sub-tabs such as Active Problem List 298 (FIG. 16M), Past Medical History 300 (FIG. 16N), Past Surgical History 302 (FIG. 16O), Family History 304 (FIG. 16P) and Social History 306 (FIG. 16Q). Social History may include input for Tobacco 308, Alcohol 310 and Drug 312 History as well as Exposure History 314, Work History 316, Travel History 318 and Home Conditions 320.

A Review of Systems (ROS) tab 322 contains links to modifiable default values or to the patient's previously inputted data. Input for systems such as Eyes, Head, Ears, Nose, Throat, Cardiac, Pulmonary, Gastrointestinal, Genitourinary, Neurological, Musculoskeletal, Endocrine, Allergy, Dermatological and Psychological may be included. See FIG. 16R.

The Medication list tab 264 and sub-tabs are also accessible at this site. See FIGS. 16S-16U.

The physical exam (PHYS EXAM) tab 324, FIG. 16V, allows for input of physical examination data such as vitals 326 including temperature, blood pressure, heart rate, respiratory rate, height, weight, date and time vitals obtained. The Physical exam tab 324 links to modifiable default values or to the patient's previously inputted data such as general appearance, eye examination findings, head, ear nose and mouth findings, heart examination findings, lung examination findings, abdominal examination findings, genital examination findings, rectal examination findings, extremity examination findings, skin examination findings, neurological examination findings and lymphatic system examination findings.

The Laboratory Results (LABS) tab 328 brings up a number of sub-tabs including Summary of Labs 330 allowing views of multiple common lab values within a single window. FIG. 16W. Other sub-tabs include Complete Blood Count 332 (FIG. 16X), Coagulation Studies 334 (FIG. 16Y), Culture Results 336 (FIG. 16Z), Electrolytes 338 (FIG. 16AA), Liver Function Tests 340 (FIG. 16AB) and Other Labs 342 (FIG. 16AC).

The Radiological Study Results (RADIOLOGY) tab 344 with sort function (FIG. 16AD) includes Name of Study 346, anatomy studied 348, date of study 350, time of study 352 and report results 354.

The Procedure Note Section (PROCEDURES) tab 356 (FIG. 16AE) allows for input of data such as the name of procedure performed, a freehand description of the procedure.

Finally, under the Use Assessment and Plan Data (A/P) tab 358, data is input for a list of working diagnosis and provides a list of interventions that correspond to the list of working diagnoses. An Assessment 360 function button is present that allows the assessment information from a previous note to be input into the current note as well as a Plan 362 function button which allows the plan or intervention information from a previous note to be input into the current note (FIG. 16AF). Further, a data field for entry of a Return to Clinic Date 364 is provided.

From the chart 242 data output notes, an organized compilation of the patient's data can be produced for viewing or printing. A variety of formats are available based on the personal preferences or the specialty of the physician. For example, some or all of the patient data may be presented to best communicate the overall condition of the patient to others.

As shown in FIG. 17-FIG. 25, a variety of other tabs are available. These may include a Preferences interface 382 to allow the entering of personal preference information as default settings for value fields for both visual and printout tailored results. Each value field described above may have several default values preset in list form to expedite entry of data into these fields. Also, associated database data may be entered in this section for ready access in final printout documentation, correspondence, prescription information, and others. This information may be separated into different tabbed sections such as Administrative, Note Value Lists, and Other.

As shown in FIG. 17, the Administrative section contains an Edit Physician section 368 with a data entry field Facility Information 366 used to enter information regarding the physician using the software such as physician name, address and telephone number, facsimile number, email address, mobile phone number and pager number and DEA number.

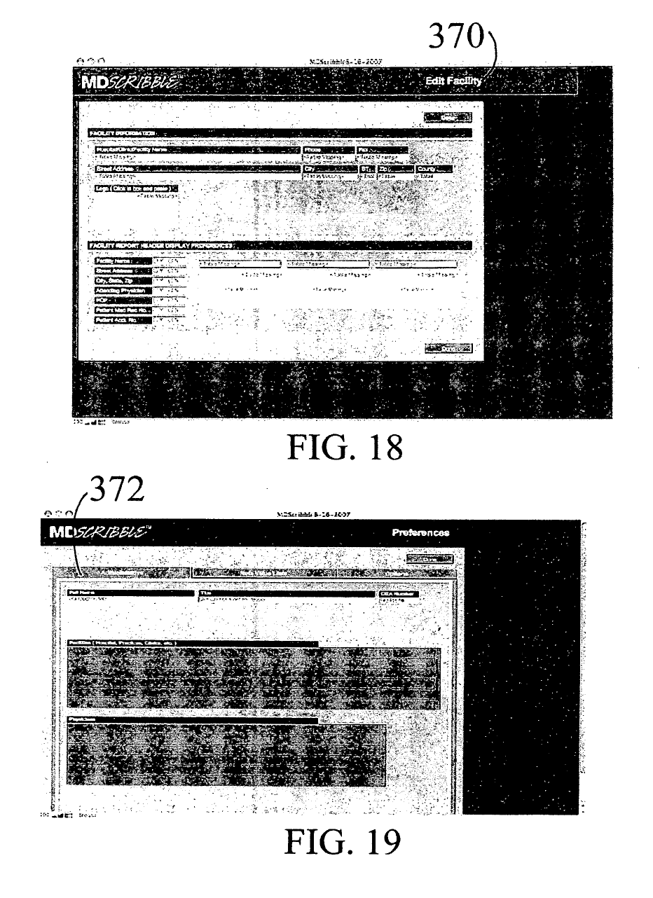

As shown in FIG. 18, an Edit Facility page 370 allows for data entry to the facility/facilities database of information regarding that physician, other physician information, and pharmacy information. This information includes facility name, address, logo, telephone number and other contact information.

Also accessible through the preferences 382 window by the administrative sub-tab 372 is a database of physicians as shown in FIG. 19. This database includes other physician names, addresses, telephone numbers and other contact information. Other databases could include a data base of pharmacies, including pharmacy name, address, telephone number, logo and other information.

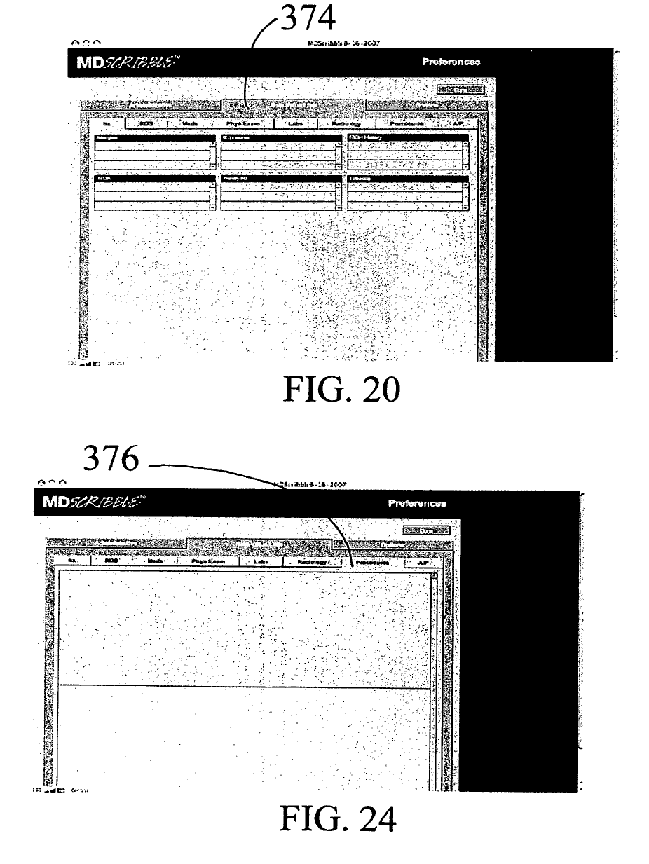

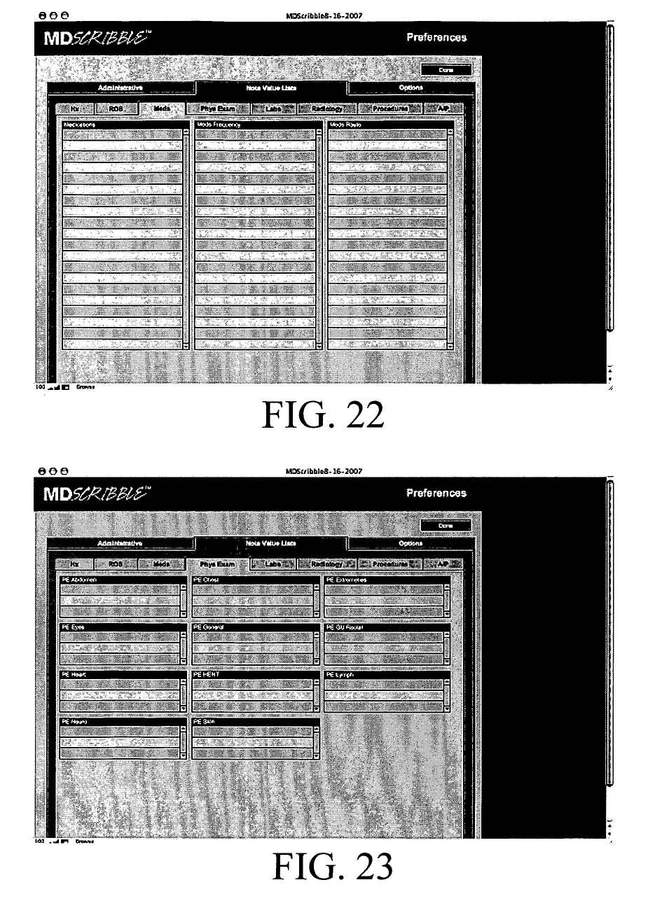

Under the Note Value Lists 374 sub-tab a physician can define the default values for entering data in various pull down lists. For example, FIGS. 20-23 show history (FIG. 20), review of systems (FIG. 21), list of commonly prescribed medications by the practitioner (FIG. 22) and the physical exam (FIG. 23).

Under Procedure notes 376 (FIG. 24) notes for commonly performed procedures by the practitioner may input.

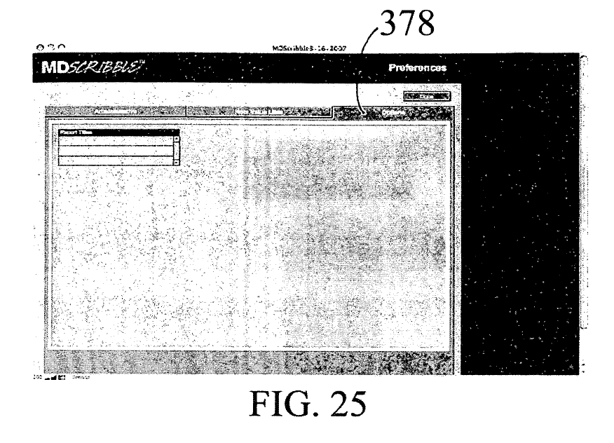

FIG. 25 shows the Other Documents (Options) section 378. This section is for components that do not readily fit into the previous categories such as Report Titles. Other databases may later be added to this subsection.

### Importing Digital Data or Images.

Images such as scanned documents, digital radiographs or photos, PDF files, or others may be added to each patient's chart and are kept in the Other Documents section. These are added by simply dragging the electronic image icon to the open data field within the Other Documents section.

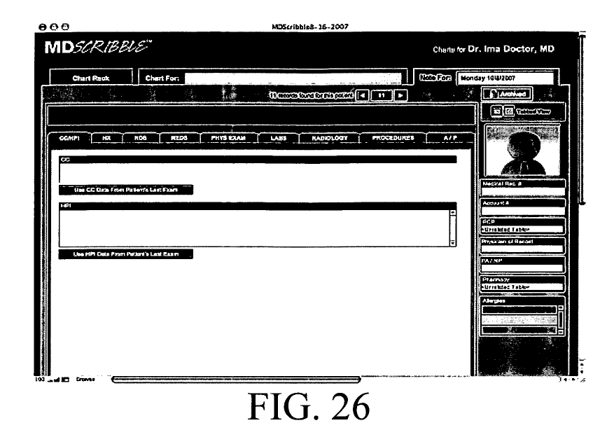

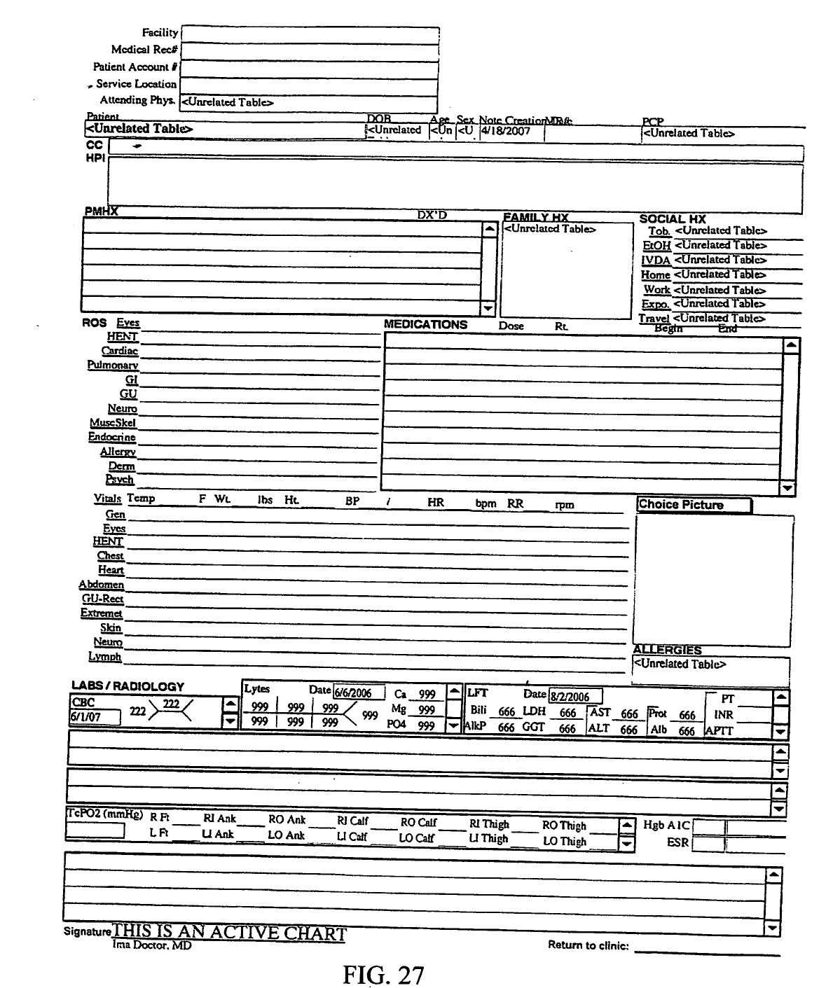

The “Archive” 380 button will freeze or create unalterable the current database information for that particular date and time. This is to be used when the documentation within the daily note is complete. It also eliminates the term “This Is An Active Chart” from the physician's signature line in the printable forms of the clinic note. See FIG. 27. Non-archived or “active” notes may be printed for review prior to archiving, but are indicated as such. Only archived notes may be printed in final form. (FIG. 26).

As also shown in FIG. 3, a user may use an interactive forms template to transmit new data to the server software 20 to be added to the database 40. To accomplish this, the user enters new data or amends existing data in the data field 74 of the forms template presented in the window of the client side browser application 22 to reflect the data to be added to the database 40. When the user electronically “signs” the template form in the signature block 78, the data currently displayed in the “signed” template form 122 is transmitted to the system software 20. The data entry module 120 receives the contents of the data fields 74 sent to the host/server 12 by the client node 50. The data entry software 120 includes a security filter module 124 which checks the validity of the data itself (does the data comply with the form and format parameters of this data field), as well as the validity of the user to submit such data. Once the full validity of the data submission has been confirmed, the data entry control module 120 transfers the data to database management software 32 and any other appropriate ancillary software modules 30 for processing. The database management software 32 then updates the database, and the ancillary software 30 transmits digital format data back to the client node 50 to refresh the forms template content presented in the window 72 of the client side browser software 22.

The security filter or module checks the data entered into the signature block 78 of the template form to verify that it was the user that “signed” the form. If this filter is passed, the data received from the client node 50 is processed by the host/server software 20, and the database 40 is updated as appropriate. Data displayed in a forms template presented in the window 72 of the client side software 22 is never transmitted to the system software 20 for processing by the database management software 32 and entry into the database 40 until the template form is electronically “signed.” Updating is the process of adding new data to the database. Existing data in the database is not modifiable, except at the highest system security level.

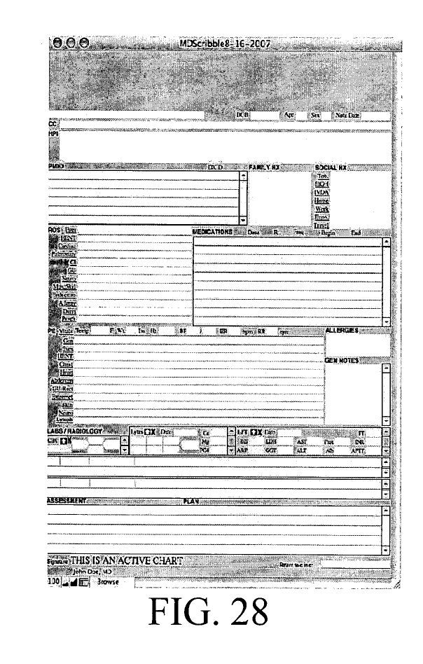

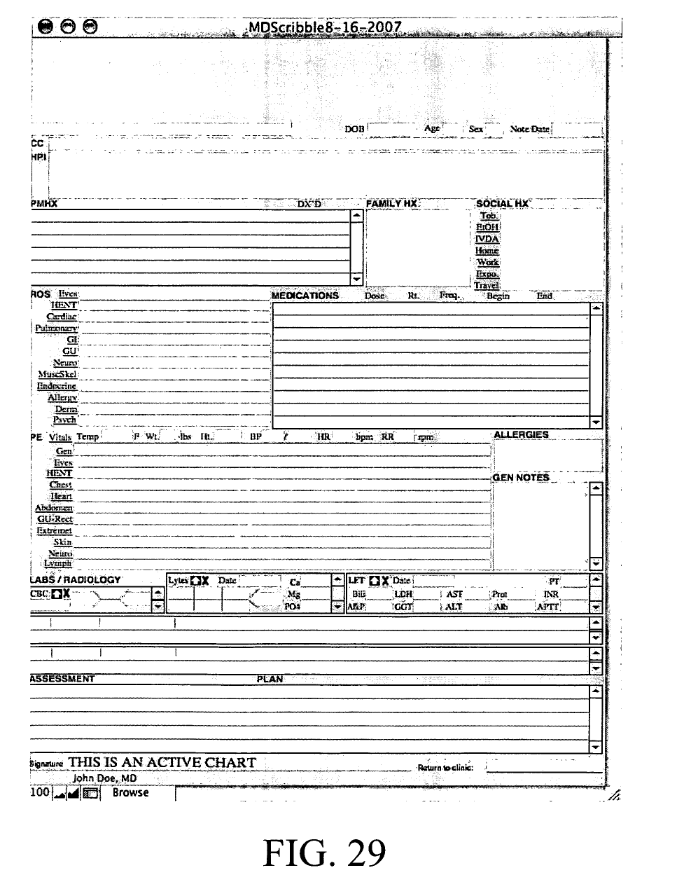

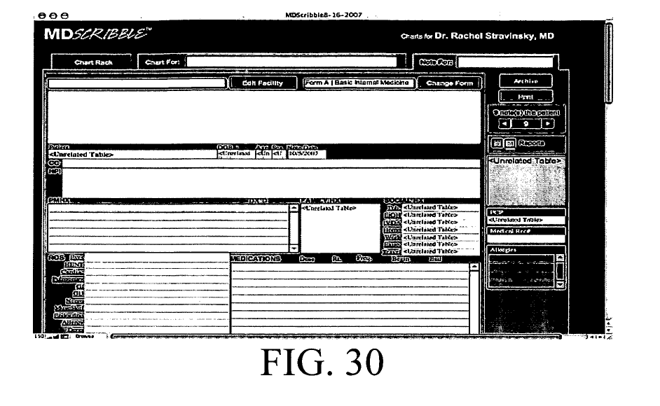

Multiple forms for printing out hard copy are available depending on the requirements of the various specialty and sub-specialty physicians and the extent of the data that needs to be presented. The patient's note may be previewed in any of the forms by choosing the Note Format Page that is under the Note section tab. From within the Note Format Page, the following types of forms may be chosen: general forms containing the information commonly found in daily clinic notes. (FIG. 28) or more specialized forms emphasizing either particular areas of anatomy, particular lab values, or particular historical data. (FIG. 29). Details of each note may be adjusted here such as the name of the facility (if the physician uses more than facility) or the particular header design. These may also be adjusted in the Preferences Section where default values may be set up. (FIG. 30).

A hardcopy 60 of the digital format data as presented in the browser window is printed out using the print function of the client side browser application 22. The printing function 150 is locally controlled at the client node 50. Preferably, the printer 52 utilized for printing the hardcopy form 60 is hardwired to the client node 50, but it may also be a networked printer. This step provides the printed, electronically documented medical billing and record form 60 of the present invention.

Other templates may include a cover letter template to generate either electronic or paper hardcopy correspondence to a patient, to another physician, or to a medical facility containing pertinent data from the clinic note or may just act as cover letters to copies of attached notes. These are found in the form section under the note tab in the note section. (Not shown)

Additionally, prescriptions forms are available for distribution by various means. A prescription may be sent electronically to a designated pharmacy by accessing the computer's pre-existing fax software and faxing the electronic prescription to the designated pharmacy. A system allowing for future interaction with an internet-based clearing house or pharmacy via broadband access utilizing encrypted data may be included.

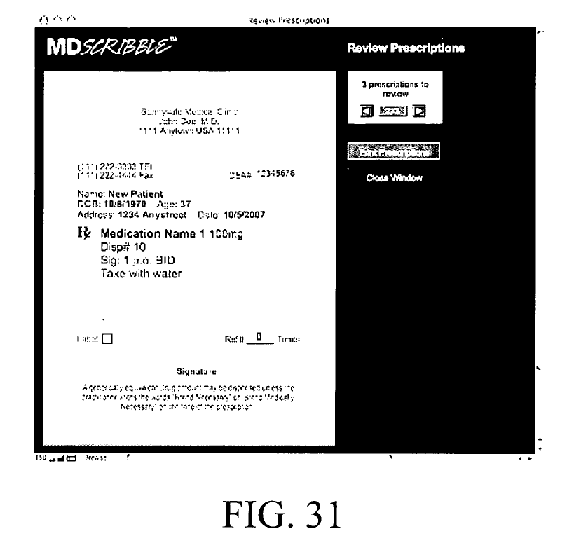

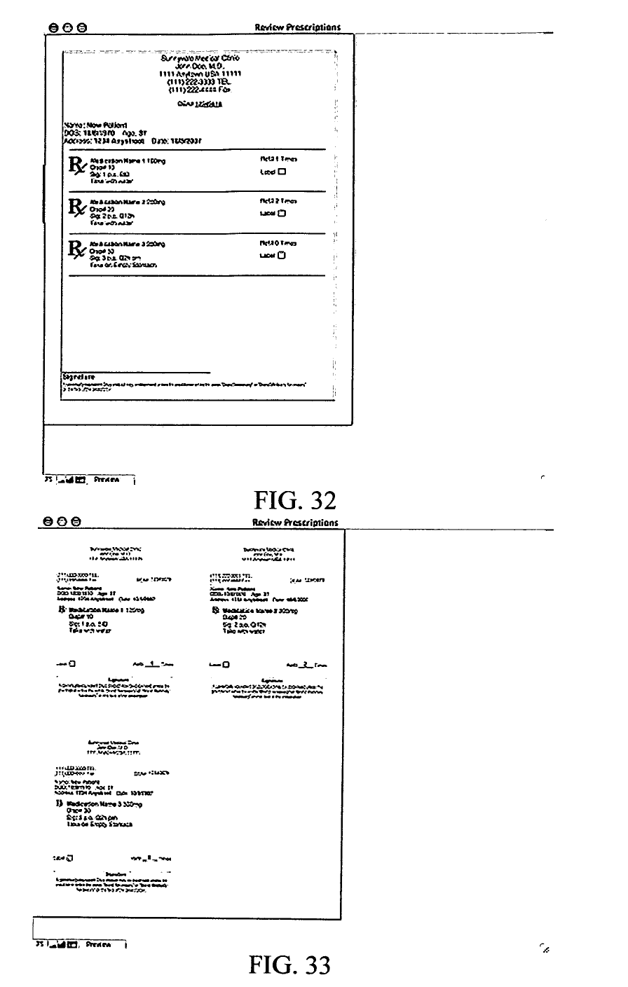

Alternatively, prescriptions may be printed out to be given directly to the patient. The prescriptions may be printed out in a variety of formats, including (a) each medication on an individual piece of tamper-resistant paper (FIG. 31), (b) multiple medications printed as a list creating a single prescription with multiple medications printed on a single sheet of tamper-resistant paper. (FIG. 32) or (c) multiple medications printed as multiple individual prescriptions on a single sheet of tamper-resistant paper. (FIG. 33).

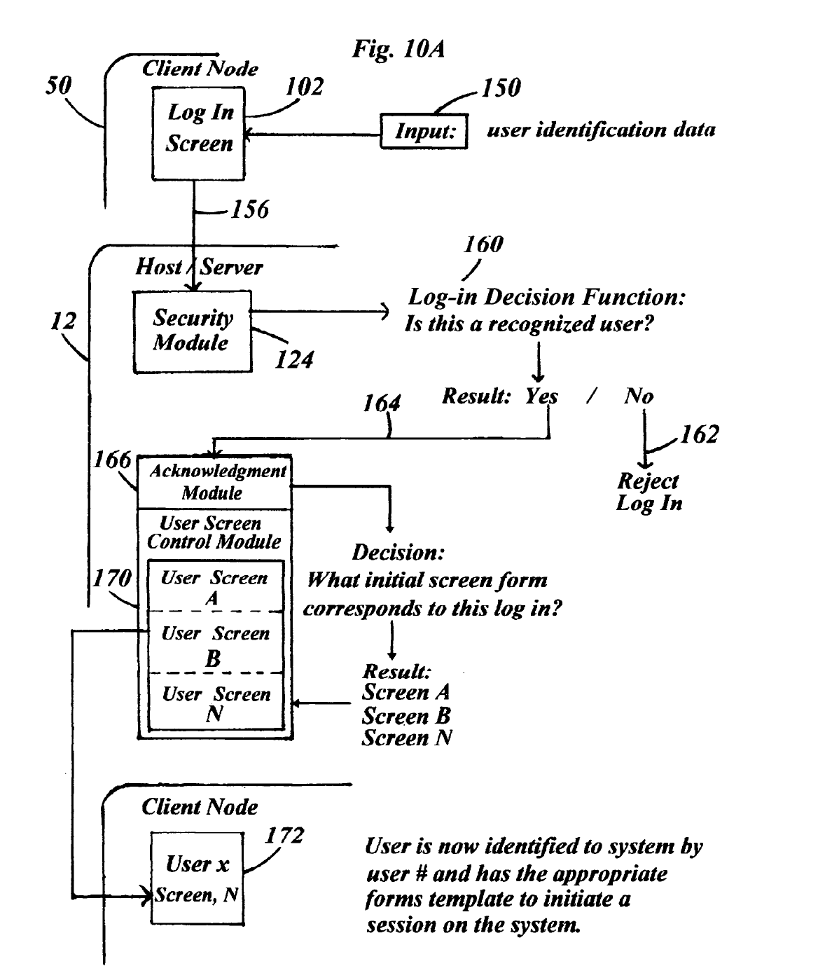

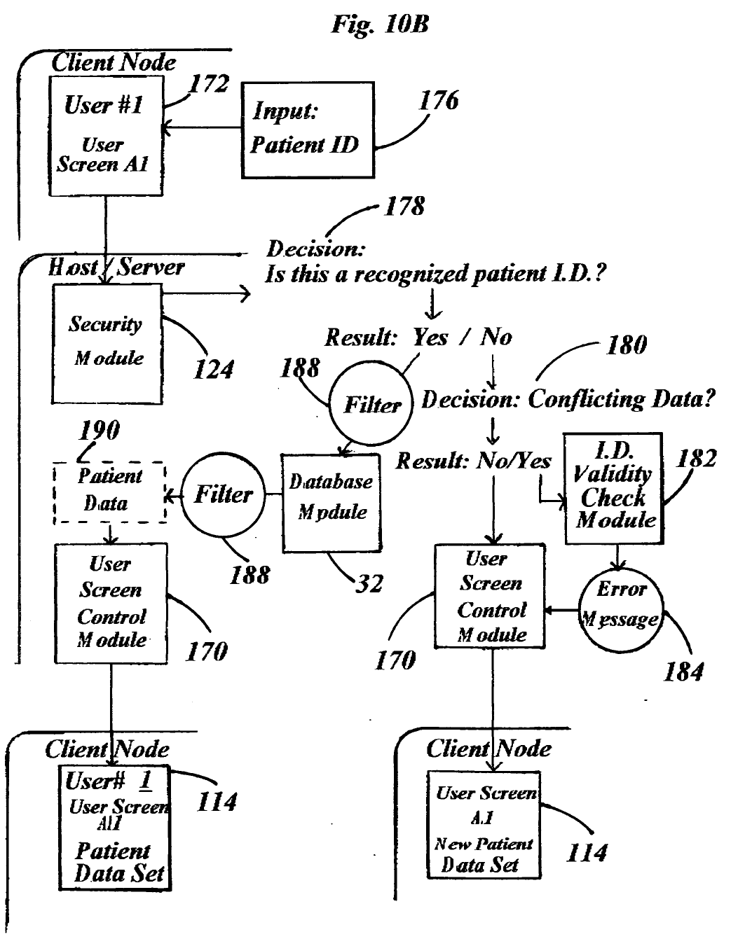

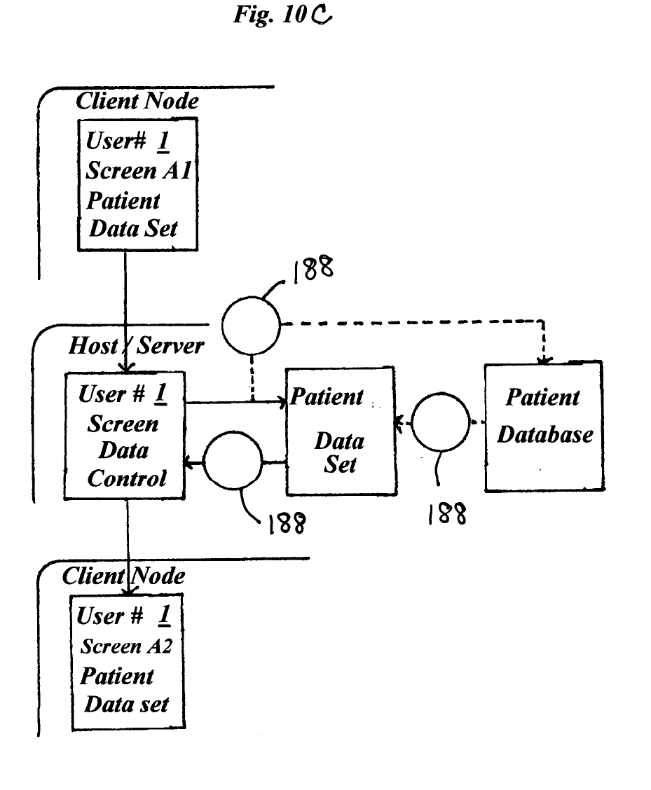

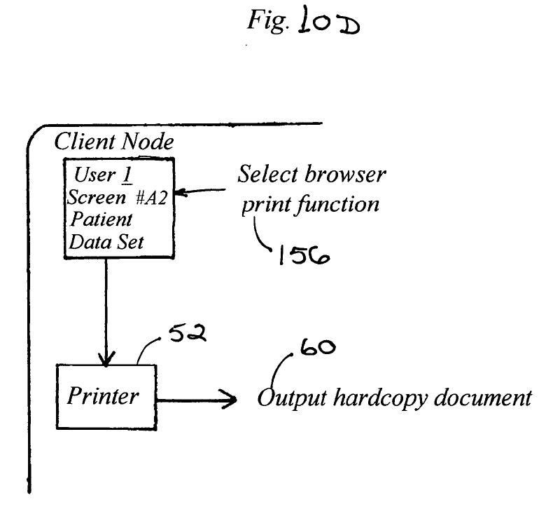

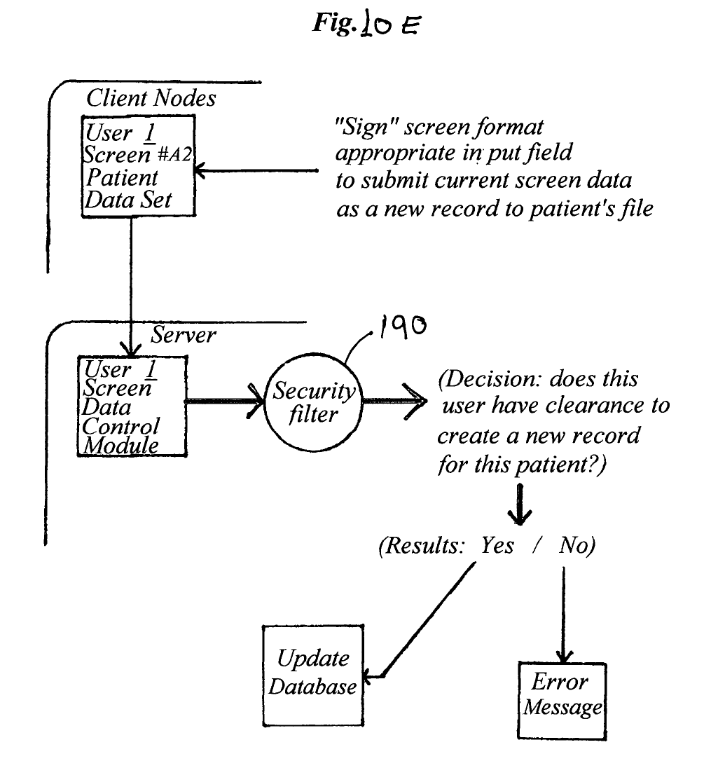

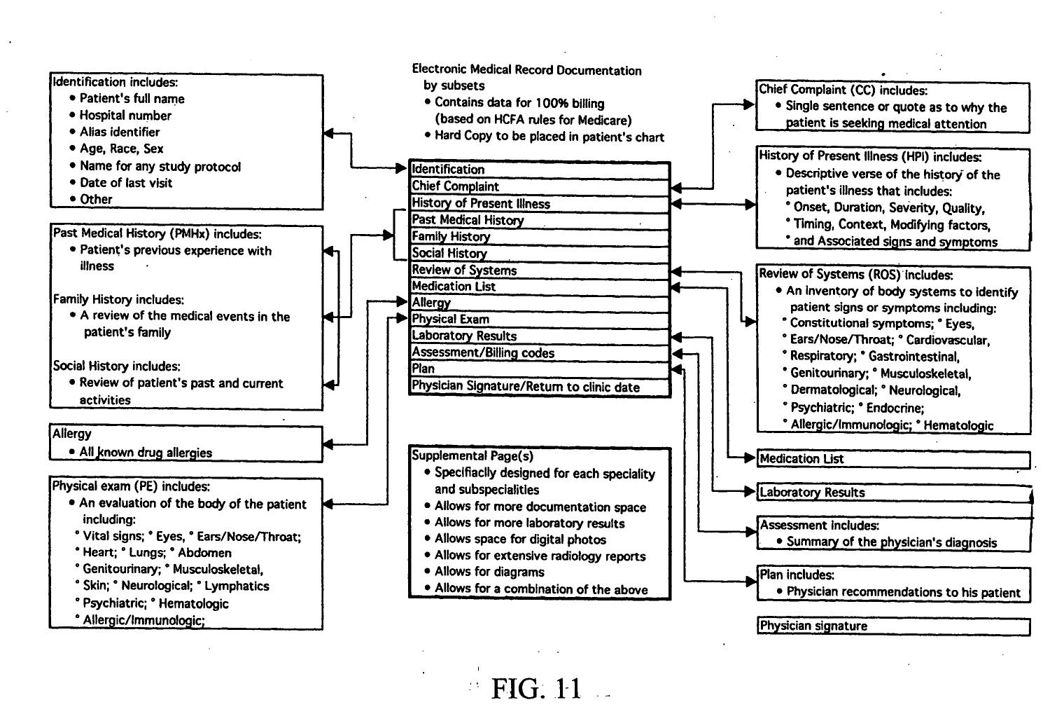

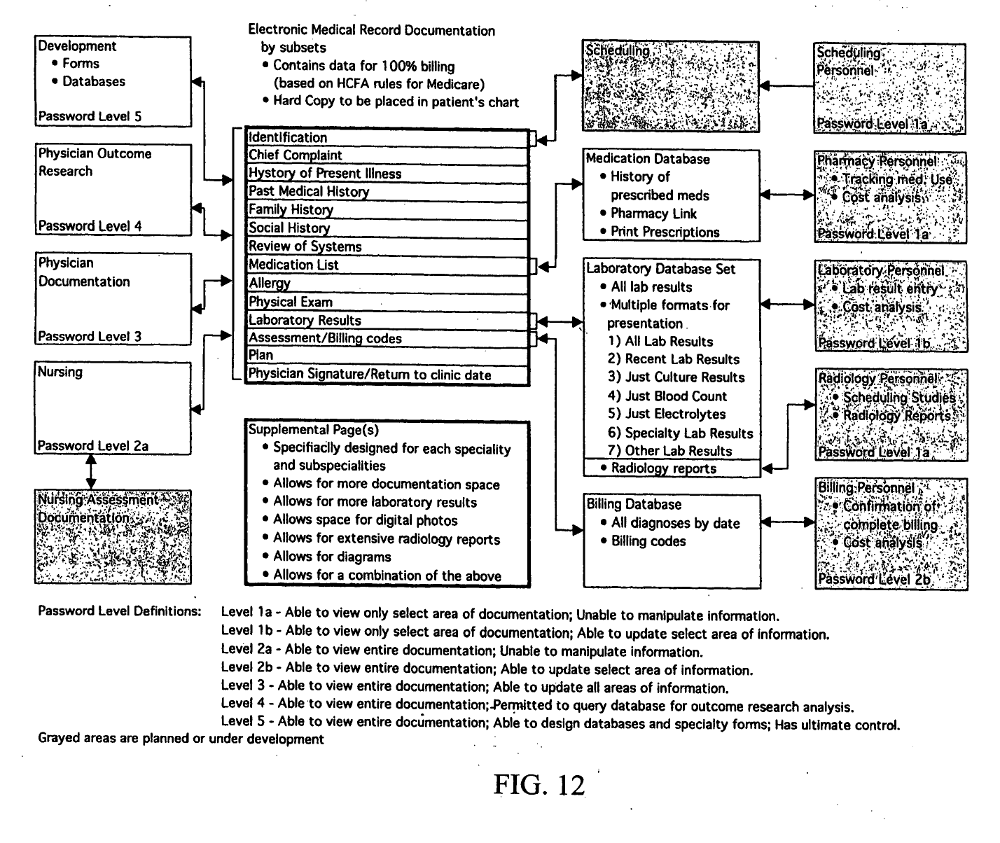

FIG. 10A is a block diagram showing the initialization step software functions in greater detail. The user enters a data set 150 of identifying data into the data fields 74 of the log-in window 102. Examples of identifying data that have been used in the practice of the present invention are: user name, user password, employee number and doctor number. The user then sends the log-in data set 150 to the host/server 12 by a browser controlled data transmission function 156. The identifying data set 150 is processed by the security software module 124, to implement the log-in decision function 16 comprising the results shown in FIG. 10A. If the decision is made to reject the log-in attempt, a reject function is executed. If the log-in attempt is accepted, the accept log-in function 164 is executed. The accept log-in function 164 is a part of the security protocol software module 124, which assigns a digital tracking tag to the user, and establishes a security level and a permission set for the user for the course of the session. Various kinds of security levels are exemplified in Table I. A permission set is a list of the locations in the database 40 that the user can access and operate on, within the limits of the user's security level. Once the log-in acceptance function 164 has been accomplished the acknowledgment function 166 is implemented. Upon receiving a valid log-in, the acknowledgment function 166 causes an acknowledgment to be transmitted back to the client node 50. The acknowledgment function determines which interactive form to present in the client side browser window 72 and sends an acknowledgment to the user that the log-in function 100 has been successfully completed. The acknowledgment function 166 implements the decision of which of the various forms templates to display in the browser window with the results exemplified in FIG. 10A. The decision is utilized by the user screen control module 170 to cause the appropriate initial user template 172 to be sent to the user's browser window 72 by the system software 20. The user's log-in is now acknowledged and the user may proceed with a session on the system of the present invention.

FIG. 10B is a block diagram showing details of the data retrieval function 110 whereby the user may retrieve permitted data from the database. The user has an interactive forms template displayed or presented in the browser window 72 of the client side software application 22. For the purpose of this example, FIG. 10B shows the forms template as an initial forms template 172 (See FIG. 5). The user enters the patient I.D. data into the date fields 74 of the initial forms template 172, as described above, the patient I.D. data 176 is sent to the host/server 12 for processing by the database management software 32 and the forms template and content transfer function 112. The patient I.D. data is received and processed by the security module 124 to implement the patient data recognition function 178 comprising the results shown in FIG. 10B. If the result is “No”, a secondary recognition function 180 is implemented with the possible results shown. If the result of the secondary recognition function is “Yes” then a validity check module 182 is run to advise the user that the patient I.D. data 176 has conflicting elements causing the system software 20 to send an appropriate message 184 advising of the conflict to be displayed in the browser window 72 of the user's client node 50. If the result of the secondary recognition function 180 is “No” then a new patient is presumed and a blank patient data interactive forms template is displayed in the user's browser window 72. If the result of the patient data recognition function 178 is “Yes”, then the recognition function 178 causes the database management software 32 to export data for the identified patient from the database 40. A security filter module 188 is used either before or after the database 40 is accessed to allow only those data that are permitted to be extracted from the database 40. The patient data is then held by a temporary data storage function 190 identified to the user for the duration of the session, until the recognition function 178 is run again or some other function deletes the temporarily stored data. The stored patient data is utilized by the user screen control module in conjunction with the user's permission set to cause the appropriate forms template and patient data content to be sent by the system software 20 to the client node 50 for presentation in the user's browser window 72. The user has now retrieved patient data from the database 40 in the user's browser window 72. The user may now edit the data and/or print out a hardcopy of the forms template as displayed in the browser window 72.

The detail of FIGS. 10C to 10E are similarly explained by the content of the figures themselves and by referral back to the text of the specification. MDScribble® also allows for the exchange of patient charts between physicians. This is accomplished by these steps: in the drop down menu “File”, choose “Prepare Chart For Export”. This command runs a script that copies and encrypts all of the archived medical record for a patient and stores it as an electronic MDScribble® file. This file can be then transferred to another physician via CD, flash drive or other data storage device. The file may also be electronically transmitted as email or over a local area network.

This electronic MDScribble® file can then be imported into the receiving physician's copy of MDScribble®. The receiving physician chooses “Import Patient Chart” from the “File” menu. At that time another script will unencrypt and import the data. If a chart for a particular patient already exists on the receiving physician's version of the software, the physician will see a pop-up screen stating this and requesting if the physician wants the charts combined. A button labeled “Sync Charts” is present that activates a script which combines the archived data of the incoming file with the data that is already present. A button labeled “Cancel” is also present that runs a script which will cancel the import of that file. Alternatively, a user may chose in the preferences section that all generated archived information is automatically combined preventing the appearance of the pop-up screen.

Additional elements which could be included in the software include real time synchronization of laboratory data from the laboratories that performed the tests, direct interaction of the software with Pharmacy computer systems for prescription processing, development of an order entry system for hospital use and versions of the software that can be used on handheld devices.

While the above description contains many specifics, these should not be construed as limitations on the scope of the invention, but rather as exemplifications of one or another preferred embodiment thereof. Many other variation are possible, which would be obvious to one skilled in the art. Accordingly, the scope of the invention should be determined by the scope of the appended claims and their equivalents, and not just by the embodiments.

What is claimed is:

1. A printed forms generating system for printing electronically documented medical billing and record forms comprising:
a client/server communications network that interfaces a dedicated host/server with all nodes on the network;
a dedicated host/server connected to the client/server network for controlling the network, and processing and storing data;
software resident on the host/server for receiving, managing, processing and transmitting patient data, medical records data, billing data, medical care codes data and forms data for accomplishing the printed forms in a digital format, and for managing a database;
a database resident on the host/server for storing data;
a client node supporting and operating a client side browser application for presenting the digital format received from the server in a window of the browser application; and
a printer for implementing a print function of the browser application to generate a printout of the digital format presented in the browser window as a printed form.

2. A process for generating and printing an electronically documented, medical billing and record form comprising the steps of:
providing a client/server network having a host/server with software resident on the host/server for receiving, managing, processing and transmitting patient data, medical records data, medical care codes data and forms data in a digital format, and for communicating with a client node via a browser application, and a client node supporting a client side browser application for communicating with the host/server.
linking the host/server's software via the network to the client side browser application for communicating with the client node;
transferring data between the client node and the host/server to accomplish the reception, management, processing, transmission and presentation of patient data, medical records data, medical care codes data and forms data;
processing the data received by the host/server from the client node with the host/server software;
presenting the data transmitted by the host/server to the client node in a window of the browser application; and
outputting a printed form of the digital format as presented in the browser window using a print function of the client side browser application, to provide the printed, electronically documented medical billing and record form.

3. The printed forms generating system of claim 1, wherein the host/server is the main computer in the client/server communications network for controlling the network.

4. The printed forms generating system of claim 1, wherein the dedicated host/server is a computer system comprising a computer selected from the group consisting of a microcomputer, a minicomputer and a mainframe computer.

5. The printed forms generating system of claim 1, wherein the client/server communications network is an arrangement comprising the dedicated host/server interconnecting all nodes, supporting hardware and software.

6. The printed forms generating system of claim 1, wherein the software on the host/server in addition to the usual software for the operation of a server further comprises server applications software, system organization and management software, data processing software and database management software for the practice of the system.

7. The software of claim 6, wherein organization and management software includes security and user management software.

8. The printed forms generating system of claim 1, wherein the client/server communications network further comprise the network having a connection for interfacing the host/server with the nodes, the connection selected from the group consisting of a hard wired connection, a wireless connection, a network connection, and a switched connection.

9. The printed forms generating system of claim 1, wherein the database comprises all the data necessary to practice the system, including user data, patient data, forms data, billing data, care codes data, medical data, and administrative data.

10. The printed forms generating system of claim 1, wherein the database further comprises at least one relational database.

11. The printed forms generating system of claim 1, wherein the node is at least one node selected from the group consisting of a client node, a printer, a terminal, an I/O port and another network.

12. The printed forms generating system of claim 1, wherein the node is a client node comprising a computer, a viewer and an interface to a printer.

13. The client node of claim 12, wherein the viewer is a computer screen.

14. The printed forms generating system of claim 1, wherein the software transmits digital format data that presents an interactive form in the window of the browser application at a client node, the client node interfaced with a printer for printing a hardcopy form of the digital format data presented in the browser window to provide the electronically documented medical billing and record form.
